(19) United States
(12) Patent Application Publication
(10) Pub. No.: US 2011/0058244 A1
(43) Pub. Date: Mar. 10, 2011

(54) ELECTROCHROMIC DISPLAY ELEMENT

(75) Inventors: Nobuyuki Kobayashi, Hyogo (JP); Noriyuki Kokeguchi, Tokyo (JP)

(73) Assignee: KONICA MINOLTA HOLDINGS, INC., Tokyo (JP)

(21) Appl. No.: 12/921,521

(22) PCT Filed: Feb. 13, 2009
(86) PCT No.: PCT/JP2009/052388

§ 371 Date: Nov. 24, 2010

(30) Foreign Application Priority Data
Mar. 13, 2008 (JP) 2008-063890

(51) Int. Cl. G02F 1/153

(52) U.S. Cl. 359/270

(57) ABSTRACT

Disclosed is an electrochromic display element which is capable of forming a full color display of high quality by a simple display element structure without performing complicated operations. The electrochromic display element is characterized by comprising a plurality of electrolyte layers and containing a redox active compound which is contained in at least one of the electrolyte layers and substantially immiscible with an adjacent electrolyte layer.

### FIELD OF THE INVENTION

The present invention relates to an electrochromic display element.

### BACKGROUND OF THE INVENTION

Over recent years, with enhancement of operation speed of personal computers, widespread use of network infrastructure, and realization of mass storage of data, as well as cost reduction of data storage, there are increasing occasions in which information of documents and images, having been conventionally provided in the form of paper printed matter, is received and viewed as more convenient electronic information.

As viewing methods for these items of electronic information, there are mainly used those which are of light emitting types such as conventional liquid crystal displays and CRTs, or organic EL displays, which have recently been marketed. Especially, however, when electronic information is composed of pieces of document information, it is necessary to stare at these viewing devices for a relatively long period of time, which is certainly not viewer-friendly. It is commonly known that light emitting type displays have disadvantages such as eye fatigue due to flicker, inconvenience of portability, limited reading posture, necessity to look directly at still images, and high power consumption for long-time reading.

As display devices to overcome these disadvantages, there are known reflective displays having memory performance, which employ external light, resulting in consuming no electrical power to retain images. However, these devices do not exhibit adequate performance due to the following reasons.

Namely, a system, employing a polarizing plate such as a reflective type liquid crystal, produces a problem in white display due to a low reflectance of about 40%, and most production methods of constituent members are neither simple nor easy. Further, polymer dispersion type liquid crystals require high operating voltage and exhibit poor contrast of resulting images due to the use of the refractive index difference between the used organic compounds. Still further, polymer network type liquid crystals have problems such that high operating voltage is required and complicated TFT circuits are needed to enhance memory capability. Yet further, display elements employing electrophoresis require a high operating voltage of at least 10 V and tend to exhibit low operation life due to electrophoretic particle aggregation.

As display systems to overcome the disadvantages of each method described above, there are known electrodeposition systems (hereinafter referred to as ED systems) and electrochromic display elements (hereinafter referred to as EC systems). Such systems are said as to have the advantages that driving can be realized at a low voltage of at most 3V; cell structures are simple; and is excellent in image display quality such that black, colors and white contrast is excellent.

When color display is tried in these systems, it is difficult to obtain sufficient white display in ED system in which a color filter is required. While it is known a method to superpose three units in each of which one of primary three colors is sandwiched by counter substrates, in EC system, there is inconvenient such that a number of the substrates increases to make white display dark, cost for substrates is expensive. Further there is known a method in which semiconductive nano porous layer is provided on one of a pair of counter electrode, and plural electrochromic dyes which is designed so as to have different coloration-discoloration threshold value (voltage, charge quantity, etc.), see, for example, Patent Documents 1 and 2. It is true that this system has simple element structure, however, there is inconvenience that it is difficult to design the compound having clear threshold value, or wave to drive coloring each color is very complicated.

### Patent Document 1: JP-A-2006-106669

### Patent Document 1: JP-A-2003-248242

### DISCLOSURE OF THE INVENTION

### Problems to be Dissolved by the Invention

The present invention has been carried out, and an object is to provide an electrochromic display which is capable of forming a full color display of high quality by a simple display element structure without performing complicated operations.

### Technical Means to Dissolve the Problems

The problems have been dissolved by the following constitution.

(1) An electrochromic display element characterized by comprising plural electrolyte layers and containing a redox active compound which is contained in at least one of the electrolyte layers and substantially immiscible with an adjacent electrolyte layer.
(2) The electrochromic display element as described in (1) above, characterized in that the redox active compound is a light control material used for an image display.
(3) The electrochromic display element as described in (2) above, characterized in that the light control material is a metal salt compound.
(4) The electrochromic display element as described in (3) above, characterized in that the metal salt compound is a silver salt compound.
(5) The electrochromic display element as described in (2) above, characterized in that the light control material is an electrochromic compound.
(6) The electrochromic display element as described in (5) above, characterized in that the electrochromic compound is a compound represented by Formula (A),

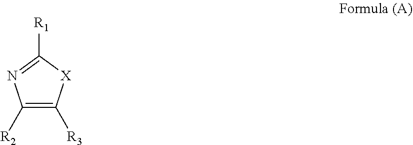

wherein R₁ represents a substituted or unsubstituted aryl group, and R₂ and R₃ each represent a hydrogen atom or a substituent, X represents >N—R₄, an oxygen atom or a sulfur atom, and R₄ represents a hydrogen atom or a substituent.
(7) The electrochromic display element as described in any one of (2) to (6) above, characterized in that the light control material is contained in every two layers of the plural electrolyte layers.
(8) The electrochromic display element as described in (7) above, characterized in that the light control material is an electrochromic compound exhibiting yellow, magenta and cyan color, and full color is displayed by laminating electrolyte layers containing the electrochromic compound.
(9) The electrochromic display element as described in any one of (1) to (8) characterized in that the element contains the redox active compound and a light control material being different from the redox active compound, and the redox active compound is allowed to redox reaction on a different pole different from the light control material in addition to redox reaction of the light control material.

### ADVANTAGE OF THE INVENTION

An electrochromic display element which is capable of forming a full color display of high quality by a simple display element structure without performing complicated operations can be provided according to the present invention.

### BEST EMBODIMENT TO PRACTISE THE INVENTION

The best embodiment to practice the present invention is described in detail.

The electrochromic display element of the present invention is characterized by comprising plural electrolyte layers and containing a redox active compound which is contained in at least one of the electrolyte layers and substantially immiscible with an adjacent electrolyte layer.

The term of miscible state of the present invention is a state that plural kinds of substance have affinity each other and form homogeneous solution or mixture. For measuring the miscible state used are conventional methods such as a method to measure degree of bleed by means of transmittance, a method observing homogeneity via an optical microscope or a polarizing optical microscope, an analytical method via thermal analysis, an analytical method via pulse NMR and so on.

A method not to allow substantially miscible in the present invention includes methods such that the redox active compound is not allowed to dissolve in liquid phase contained in the adjacent electrolyte layer when the redox active compound is solid, the redox active compound is not allowed to mix with liquid phase contained in the adjacent electrolyte layer when the redox active compound is liquid, the redox active compound is not allowed to mix by making the difference of solubility parameter large between the liquid composing the liquid phase and liquid in the adjacent layer when the redox active compound is dissolved in liquid state electrolyte, or the like. Parameters exhibiting indices of the compound include molecular weight, solubility in various solvent, SP value, number of carbon atom, valences, Tg, melting point and so on. Practical example includes that a method to employ a compound having molecular weight of 200 or less and a polymer compound having molecular weight of 1,000 or more, which have remarkably different SP values each other, a method to employ compounds having number of carbon atoms different from by eight each other, a method to employ compounds having same ionicity as cation or anion, and the like. Further, a method preventing miscibility or retarding the diffusion rate of the substance by enhancing physical strength of the electrolyte via blending polymer bonder in the electrolyte layer is mentioned

According to the present invention, manufacturing process is simple because of it is possible to stack the electrolyte layers, and redox reaction can be controlled independently in each layers, insufficient compound does not diffuse since mobility of the compound is restricted due to miscibility, and the effect to improving therefore redox reaction efficiency is obtained in addition to the advantage of the present invention.

The redox active compound of the present invention includes any compound as far as it is oxidized and reduced by electrode reaction. The redox active compounds include conventionally known compound, for example, a pyridyl compound such as viologen, heptyl viologen, phenanthroline and bipyridine, an electroconductive polymer such as polypyrrol, polyaniline, polythiophene, a styryl compound such as 2-[2-[4-(dimethylamino)phenyl]ethyl]-3,3-dimethylindolino[2,1-b]oxazolidine, a donor/acceptor type compound such as tetracyanoquinodimethane, tetrathiobullvalene and TTF, organic metal complexes such as Prussian blue, a metal-bipyridyl complex, a metal phenanthroline complex, metallocene, a metal-phthalocyanine complex, organic compounds such as diphenyl amine, amino phenol, Tris-amino phenylamine, phenyl acetylene, a cyclopentyl compound, carbazole, methoxybiphenyl, anthraquinone, a benzodithiolium compound, a squarylium salt, cyanine, merocyanine, pyrazoline, hydroxylamines, redox indicator, pH indicator, nitroxyl radicals, quinones and hydroquinones.

The term of “the redox active compound is a light control material used for an image display” in the present invention means that the redox active compound is a material which changes markedly absorption at ultraviolet light-visible light-infrared light and has a function to display an image by changing markedly the optical density of the display element.

### (Electrochromic Compound)

Electrochromic compound which is the redox active compound of the present invention can be used preferably as the light control material.

It is preferable that the electrolyte layer described above contains an electrochromic compound, full color display is conducted by color change exhibiting yellow, magenta and cyan color by virtue of oxidization and reduction reaction of the electrochromic compound via driving operation of counter electrodes in the present invention.

In the display element of the present invention, any compound is usable as an electrochromic compound (hereafter, referred to as an EC compound) as long as the compound exhibits a phenomenon in which the nature of optical absorption (color or optical transmittance) is reversibly changed by means of electrochemical oxidation-reduction (electrochromism). As specific compounds, the compounds described in “Electrochromic Display”, p 27-124 (Jun. 28, 1991, published by Sangyo Tosho Co., Ltd.) and in “Development of Chromic Material”, p 81-95 (Nov. 15, 2000, published by CMC Co., Ltd.) are cited.

In the display element of the present invention, the electrochromic compound is preferably a metal complex coordinated with at least one organic ligand having a carbon-nitrogen double bond as the substructure.

The metal which constitutes the metal complex is not specifically limited as long as the metal can be coordinated with a ligand having a carbon-nitrogen double bond as the substructure, examples of which include group 8 metals of the periodic table (iron, ruthenium and osmium), group 9 metals in the periodic table (cobalt, rhodium and iridium), lanthanoid metals (dysprosium, ytterbium and lutetium), nickel and copper. Of these, iron and cobalt are preferable.

The metal complex according to the present invention has a feature that the colored state varies according to the oxidation-reduction reaction. The colored state of the metal complex preferably varies in the voltage range of −3.5V to 3.5V and more preferably in the voltage range of −1.5V to 1.5V.

Specific examples of an organic ligand having a carbon-nitrogen double bond as the substructure include: hydrazones (for example, hydrazone, azine, semicarbazone, isosemicarbazone, carbohydrazone, hydrazone acid, hydrazidine and amidrazone), oximes (for example, oxime, hydroximic acid and amidoxime), imines, and nitrogen-containing heterocyclic compounds (for example, pyrazole, imidazole, thiazole, oxazole, triazole, oxazole, triazole, oxadiazole, thiadiazole, pyridine, pyridazine, pyrimidine, pyrazine, triazine, benzimidazole, purine, quinoline, isoquinoline, quinoxaline, phenanthroline, porphyrin, phthalocyanine, pyrroline, imidazoline, pyrazoline, pyrazolone, oxazoline and thiazoline).

Among these organic ligands, a polydentate ligand, specifically, a bidentate ligand or a tridentate ligand is preferable, specific examples of which include: bipyridines, terpyridines, phenanthrolines, tetrazolyl-pyridines, pyridyl-quinazolines, bis-isoquinolines, pyridyl-azines and pyridyl-benzimidazoles.

Further, the organic ligand having a carbon-nitrogen double bond as the substructure is preferably represented by abovementioned Formula (I).

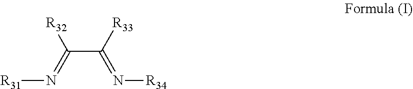

In the abovementioned Formula (I), R₃₁, R₃₂, R₃₃ and R₃₄ each independently represent a hydrogen atom, an amino group, a hydroxy group, a mercapto group, an alkoxy group, an alkyl group, an alkenyl group, an alkynyl group, an aryl group or a heterocycle group, and these substituents may further have a substituent. Further, R₃₁ and R₃₂, R₃₂ and R₃₃, and R₃₃ and R₃₄ each may be connected with each other to form an aromatic or non-aromatic ring structure, and each ring structure may have a substituent at an arbitrary position of the ring structure.

Preferable is a compound in which R₃₁ and R₃₂, R₃₂ and R₃₃, and R₃₃ and R₃₄ each are connected with each other to form an aromatic or non-aromatic ring structure.

When R₃₁ and R₃₂, are connected with each other to form a ring structure, the organic ligand having a carbon-nitrogen double bond as the substructure is preferably represented by following Formula (II).

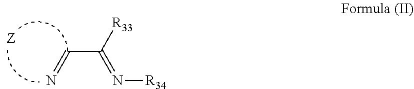

In above Formula (II), R₃₃ and R₃₄ each have the same meaning as those in Formula (I), and Z represents a group of atoms necessary to form a ring structure together with C═N. These ring structures may have a substituent at an arbitrary substitutable position of the ring structure. These ring structures preferably are heteroaromatic ring structures.

Specific examples of the moiety of a ring structure from which substituent is omitted will be shown below, however, the present invention is not limited thereto. In the ring structures shown below * represents a bond position.

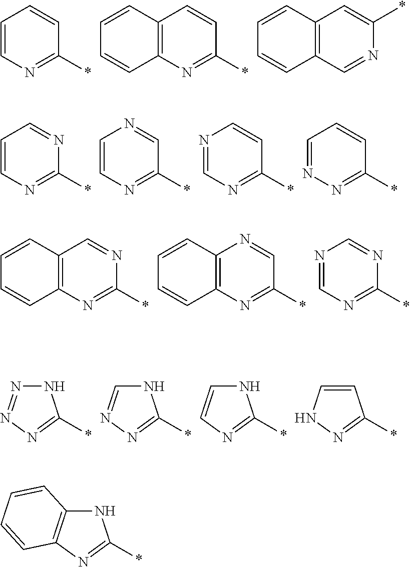

When R₃₁ and R₃₂, and R₃₃ and R₃₄, each are connected with each other to form a ring structure, the organic ligand according to the present invention having a carbon-nitrogen double bond as the substructure is preferably represented by following Formula (III).

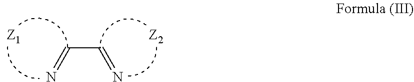

In above Formula (III), Z₁ and Z₂ each represent a group of atoms necessary to form a ring structure together with C═N. The ring structures of the compound represented by Formula (III) may have a substituent at an arbitrary substitutable position of the ring structures. The substituent is not specifically limited and may be a substituent listed above as specific ring structures.

Further, when R₃₂ and R₃₃ are connected with each other to form a ring structure, the organic ligand according to the present invention having a carbon-nitrogen double bond as the substructure is preferably represented by following Formula (IV).

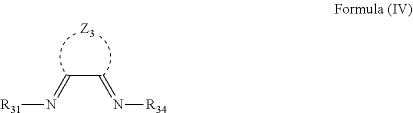

In above Formula (IV), R₃₁ and R₃₄ each have the same meaning as those in Formula (I), and Z₃ represents a group of atoms necessary to form a ring structure together with the two carbon atoms. The ring structure may have a substituent at an arbitrary substitutable position.

Among Formulas (I) through (IV), specifically preferable are following Formulas (V) and (VI).

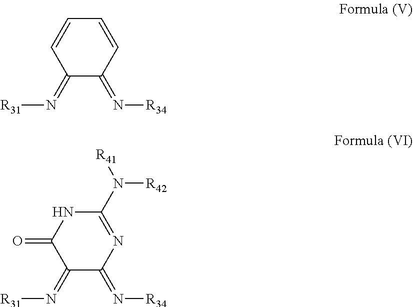

In above Formula (V), R₃₁ and R₃₄ each have the same meaning as those in Formula (I). In above Formula (VI), R₄₁ and R₄₂ each represent an alkyl group which may have a substituent.

In view of the adhesion with the electrode surface and the durability of the film, the organic ligand according to the present invention having a carbon-nitrogen double bond as the substructure preferably has at least one adsorbing group which chemically or physically adsorbs to the electrode.

The chemical adsorption according to the present invention is a comparatively strong adsorbed state via a chemical bond with an electrode surface, and the physical adsorption according to the present invention is a comparatively weak adsorbed state via the van der Waals force committed between an electrode surface and adsorbate.

The adsorbing group according to the present invention is preferably a chemically adsorbing group. Examples of a chemically adsorbing group include: —COOH, —P—O(OH)₂, —OP═O(OH)₂ and —Si(OR)₃, wherein R represents an alkyl group.

Specific examples of an organic ligand having a carbon-nitrogen double bond as the substructure according to the present invention and an organic ligand having further an adsorbing group which chemically or physically adsorbs to an electrode surface will be shown below, however, the present invention is not limited thereto.

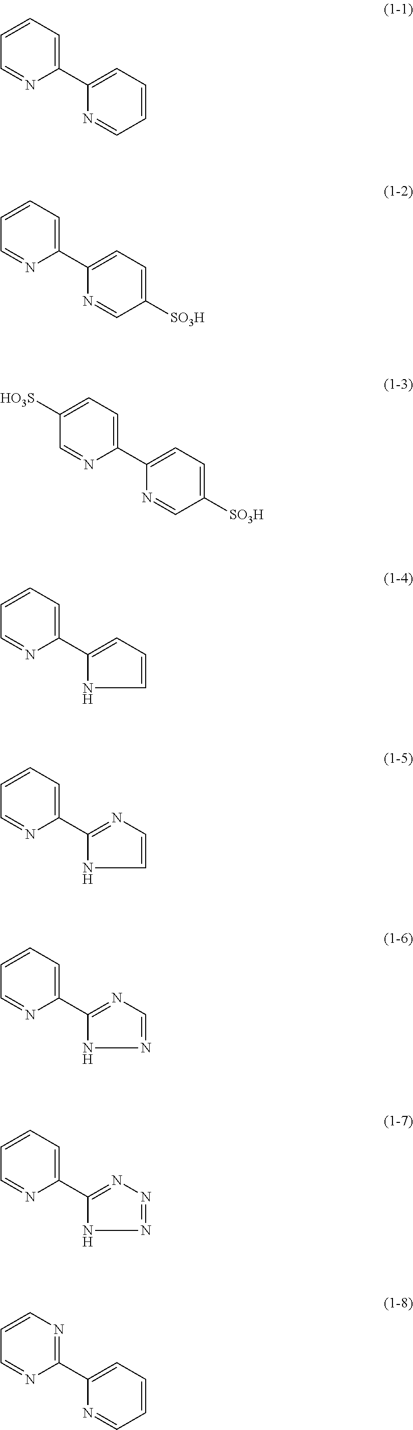

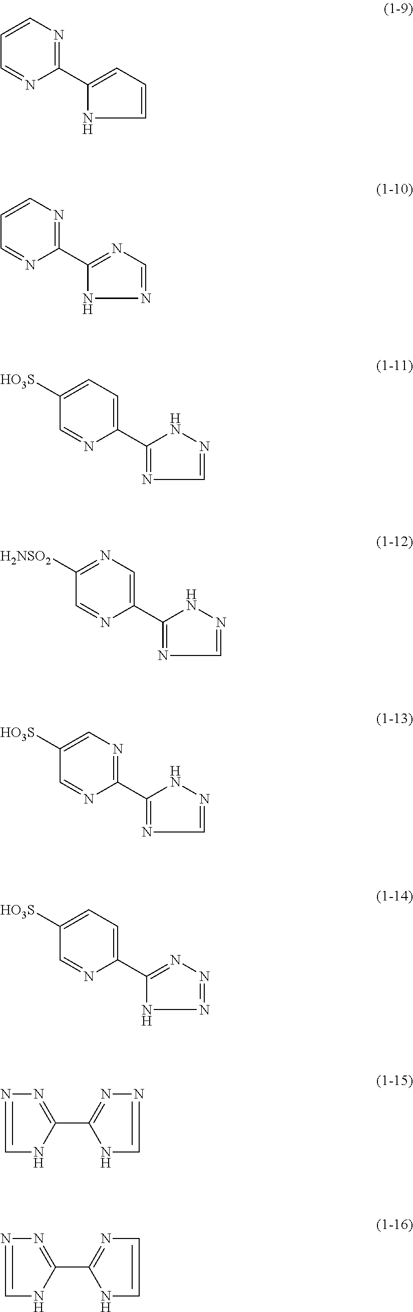

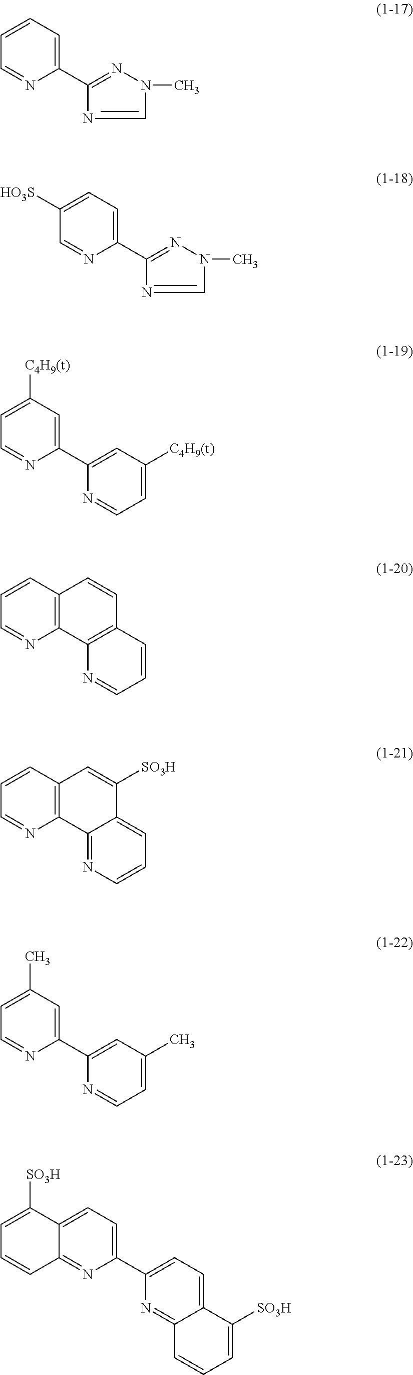

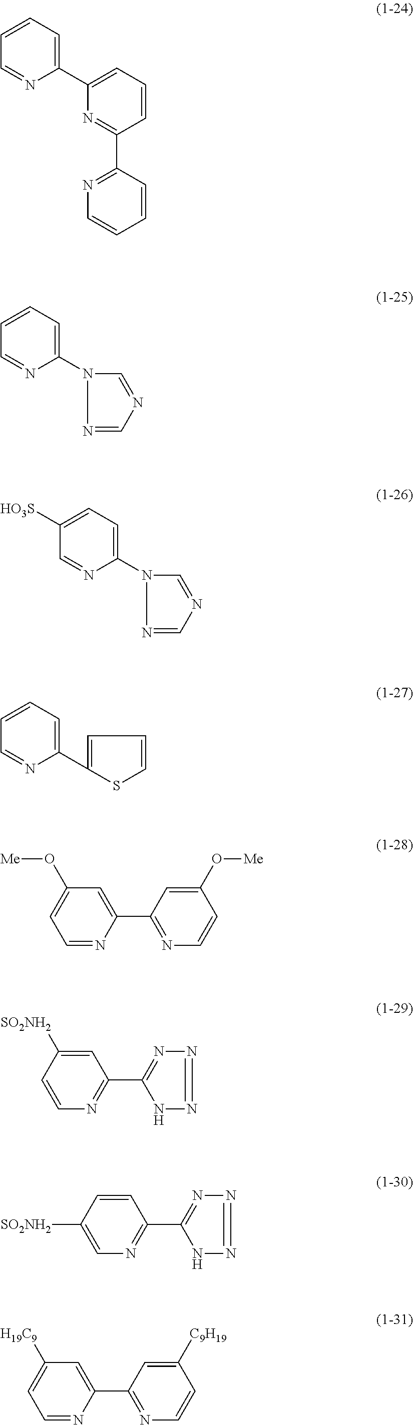

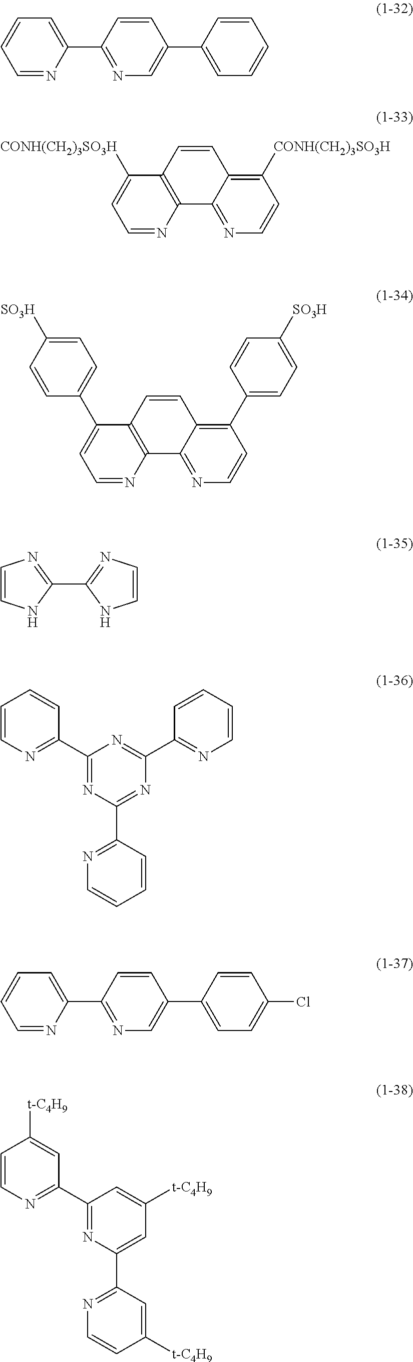

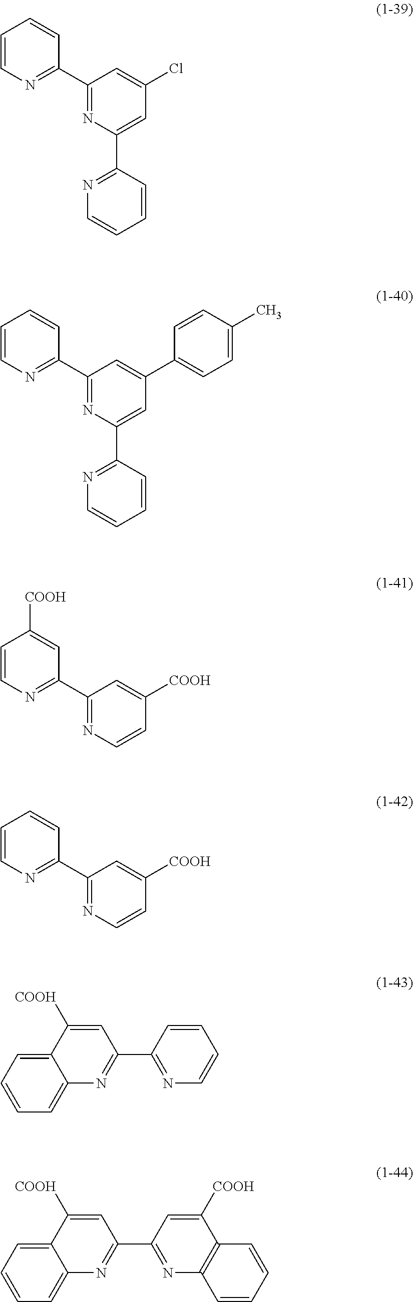

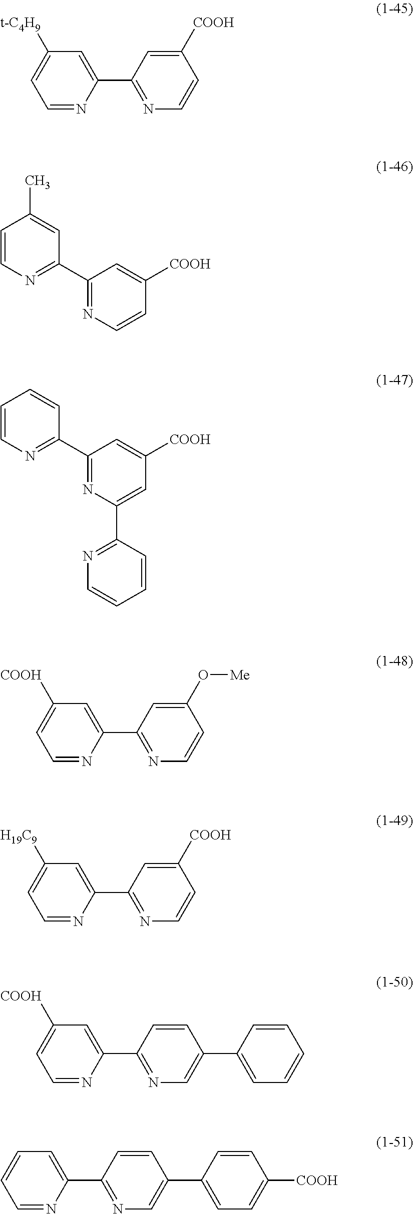

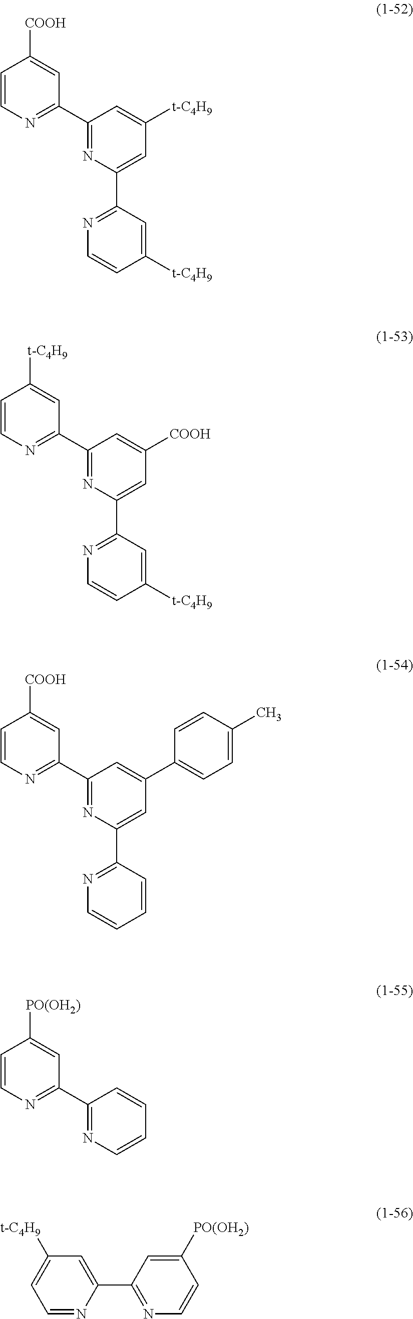

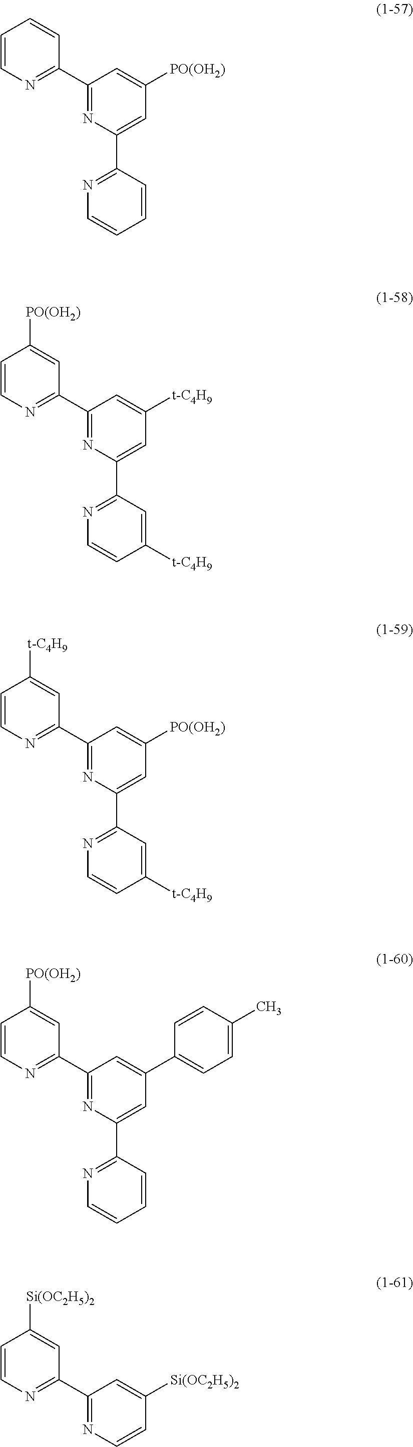

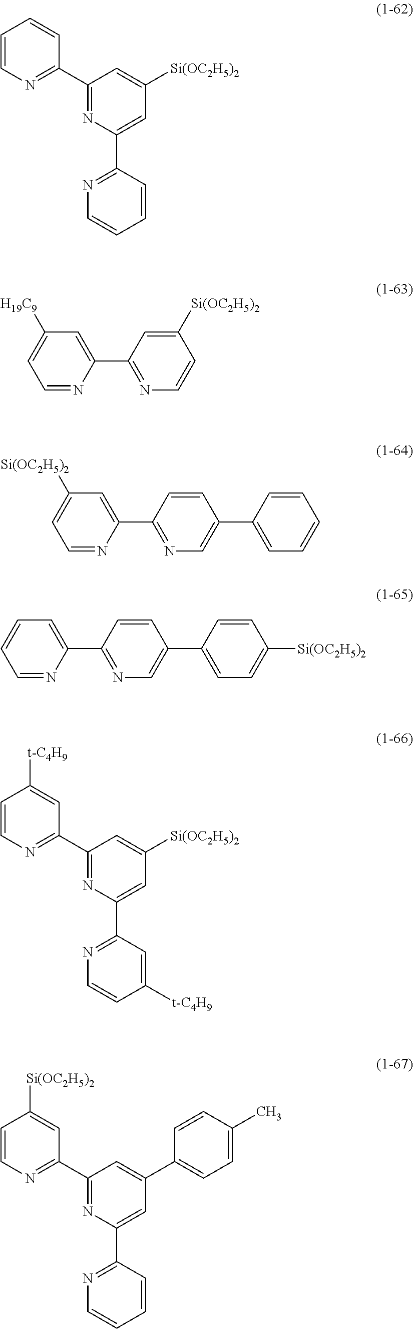

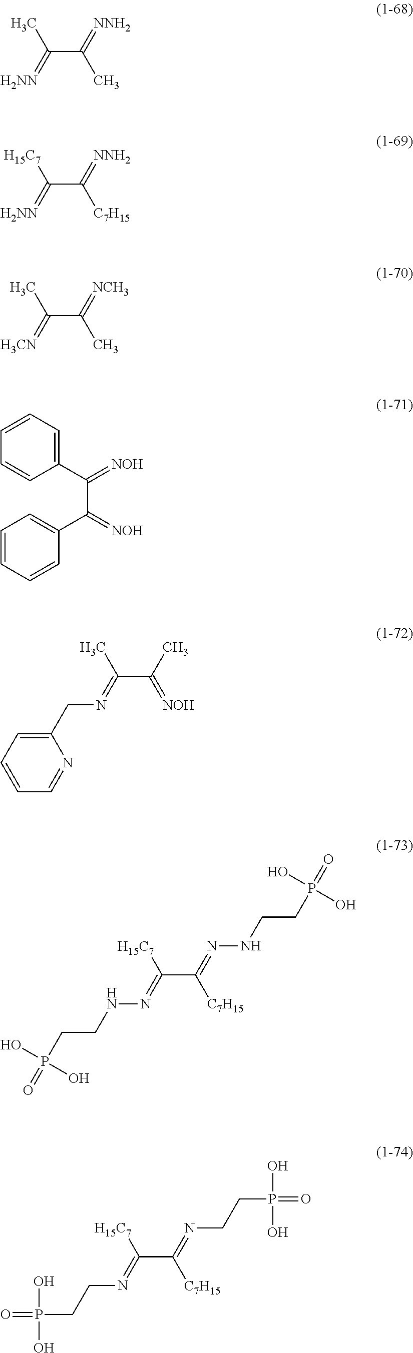

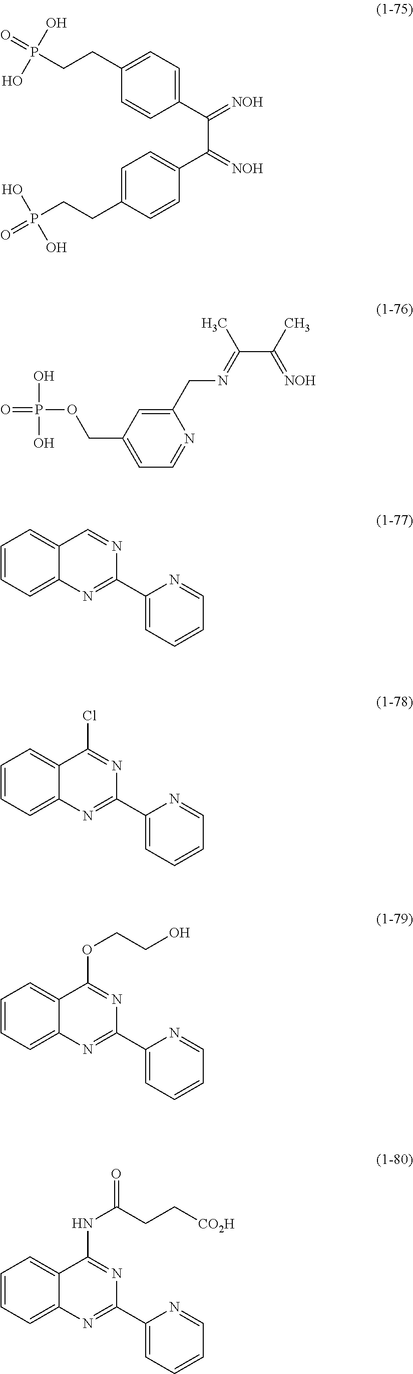

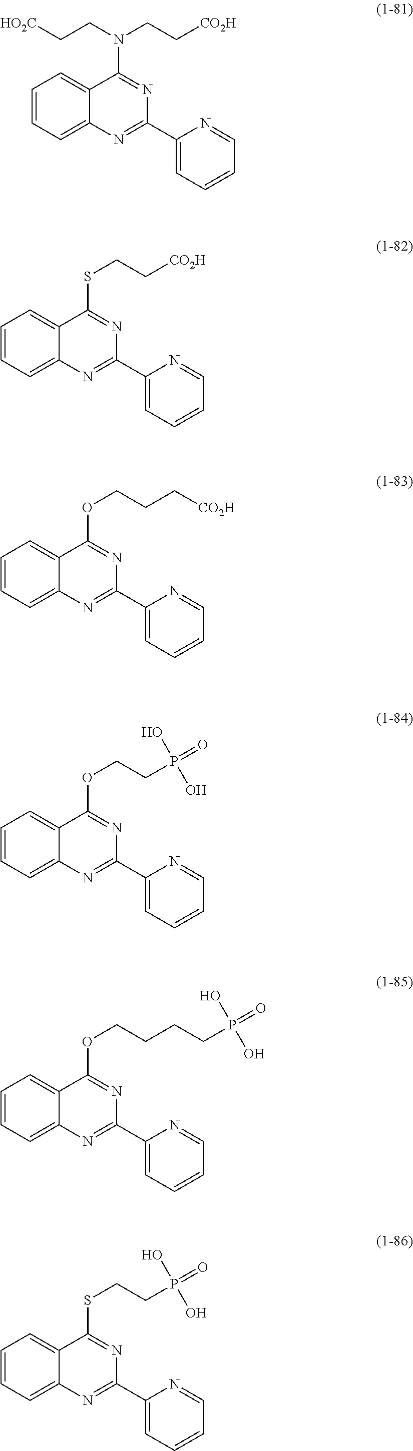

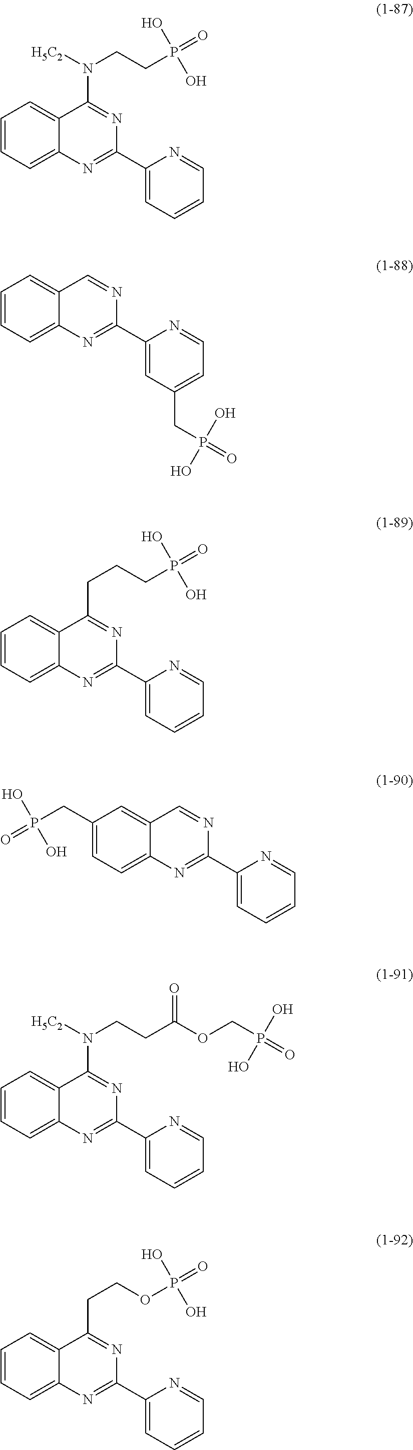

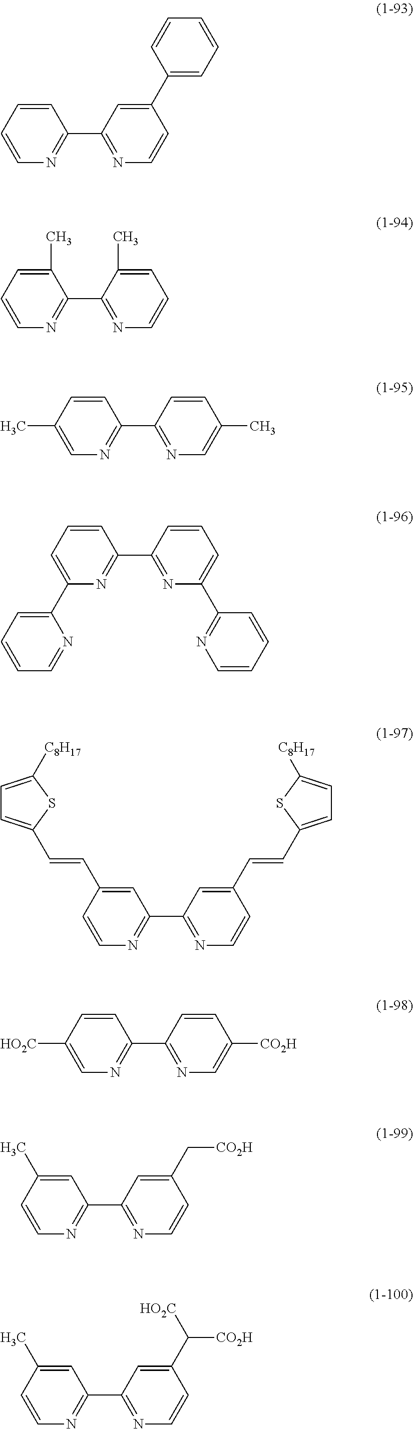

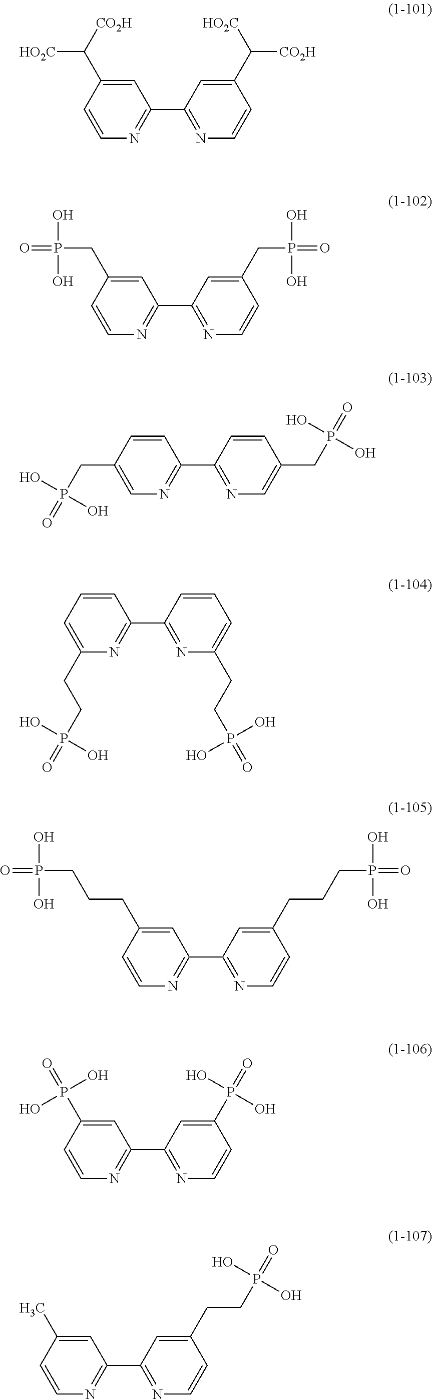

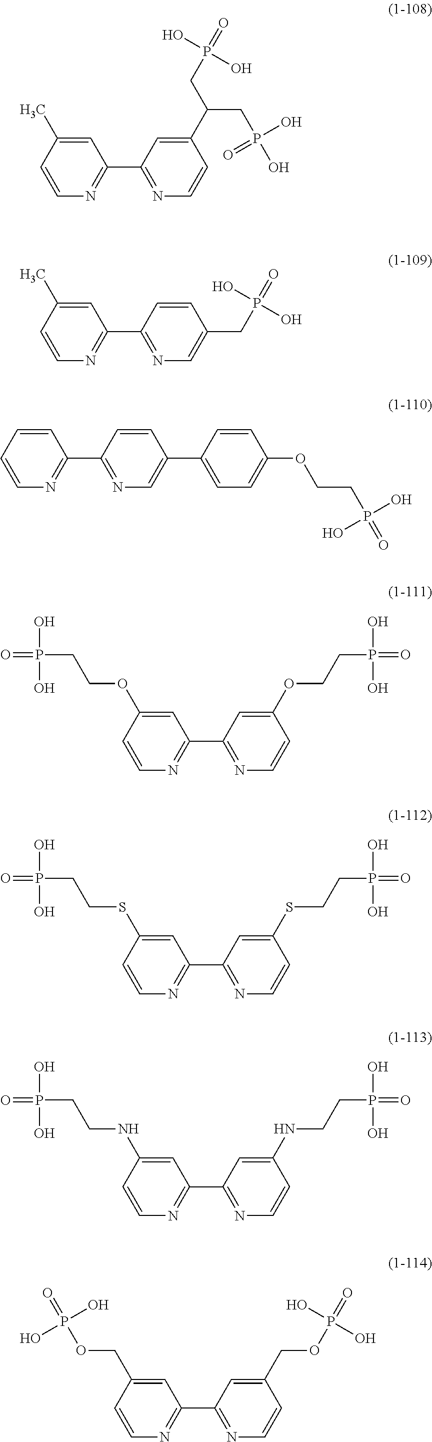

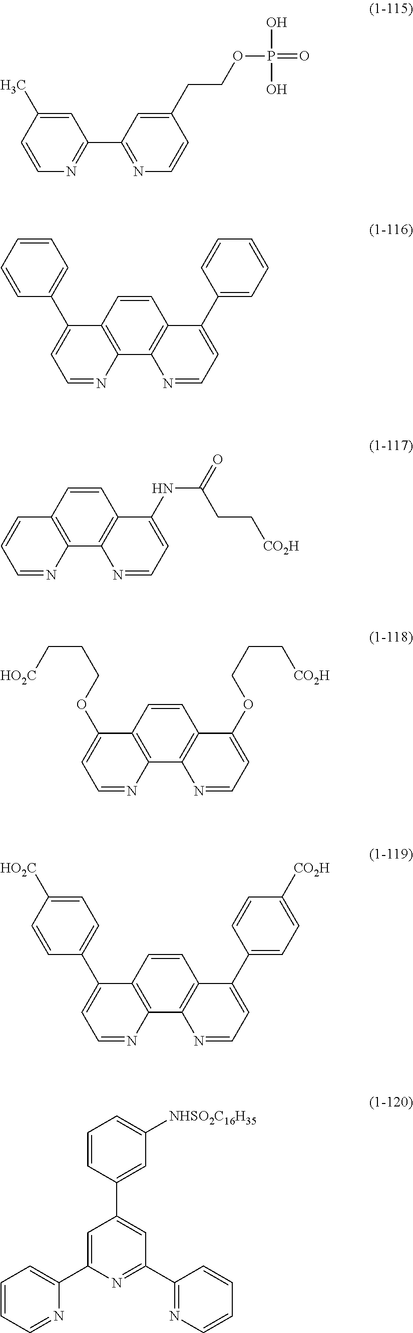

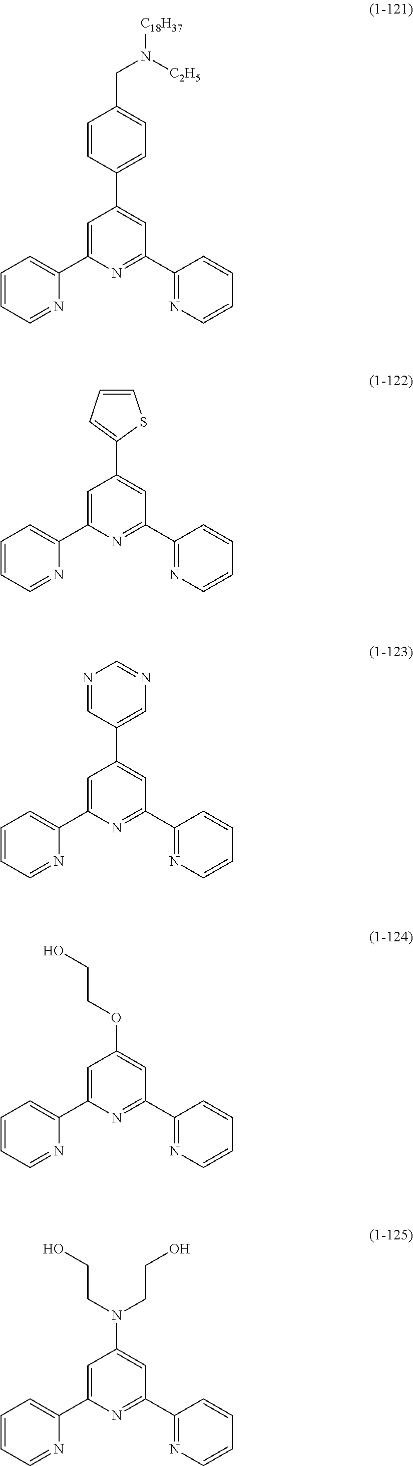

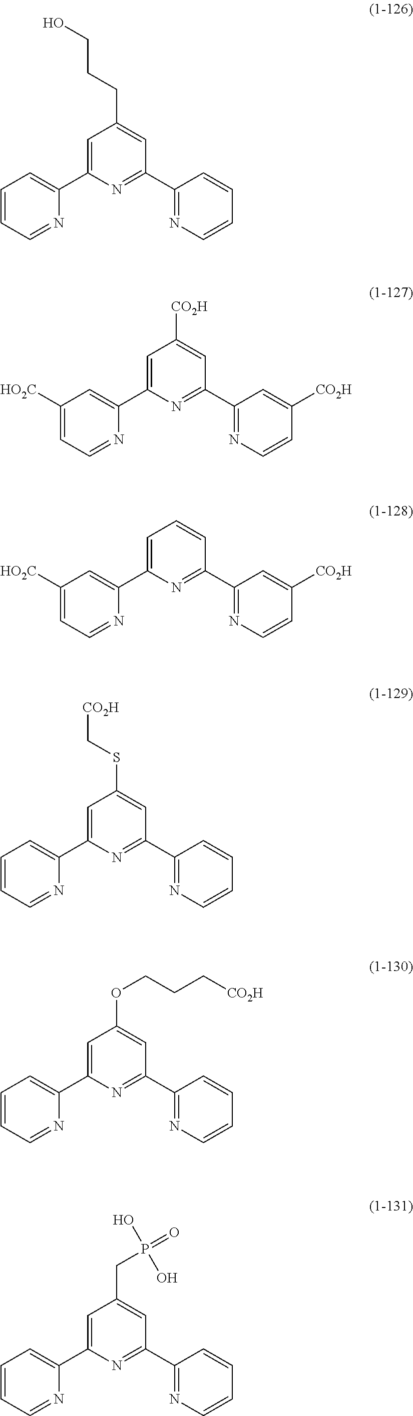

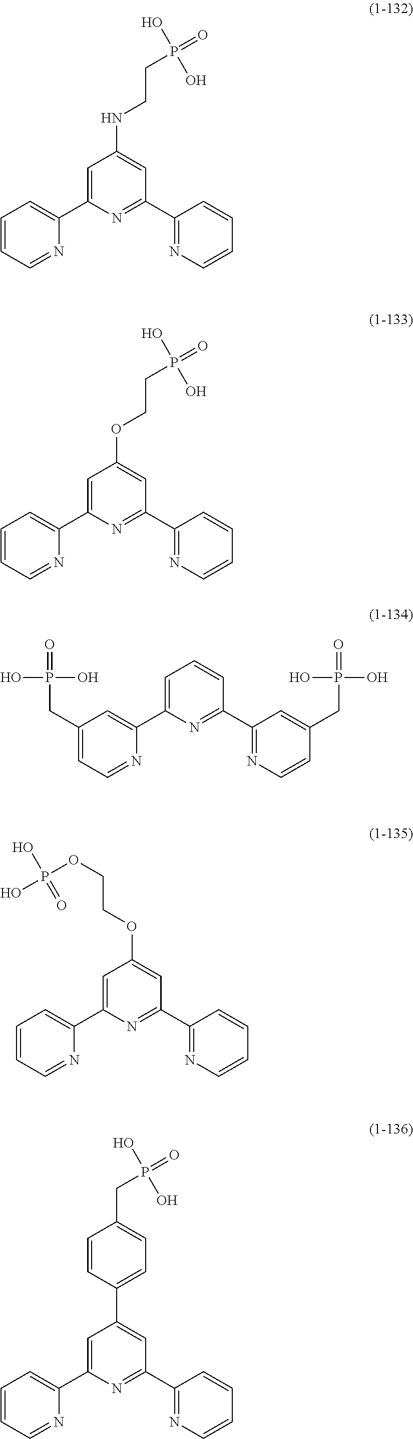

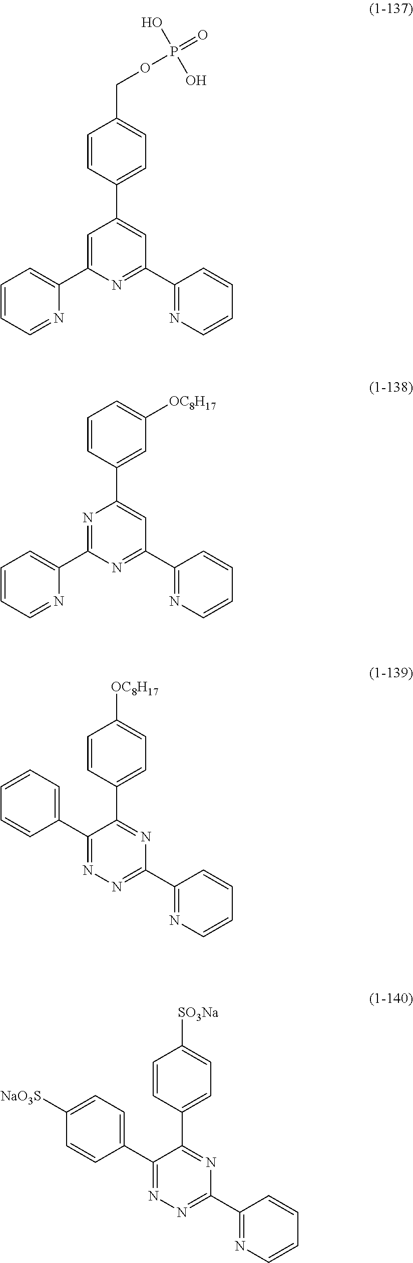

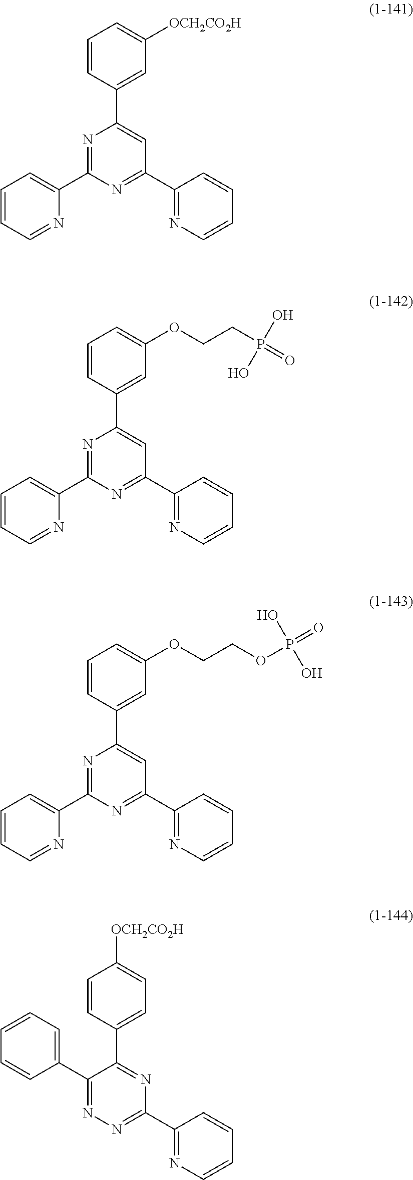

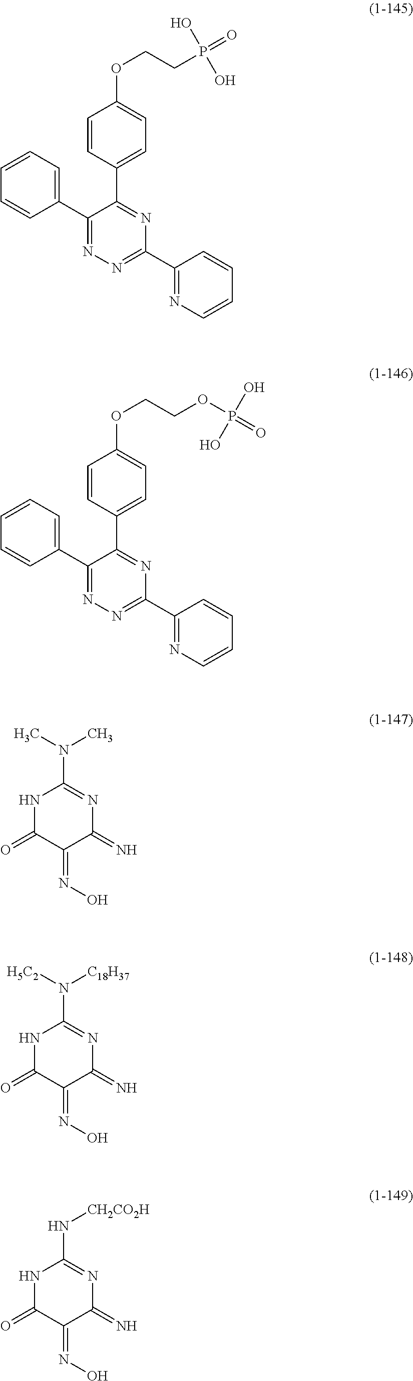

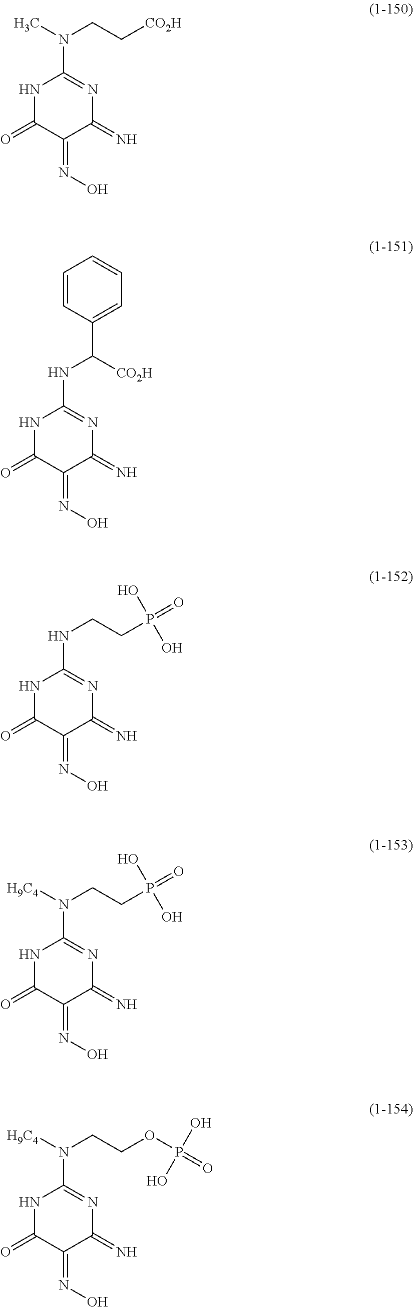

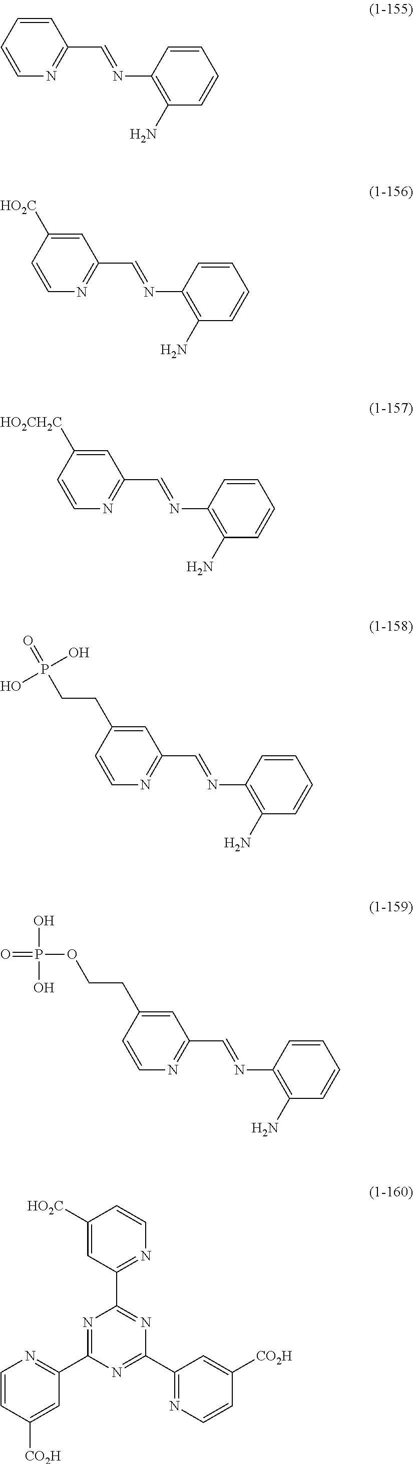

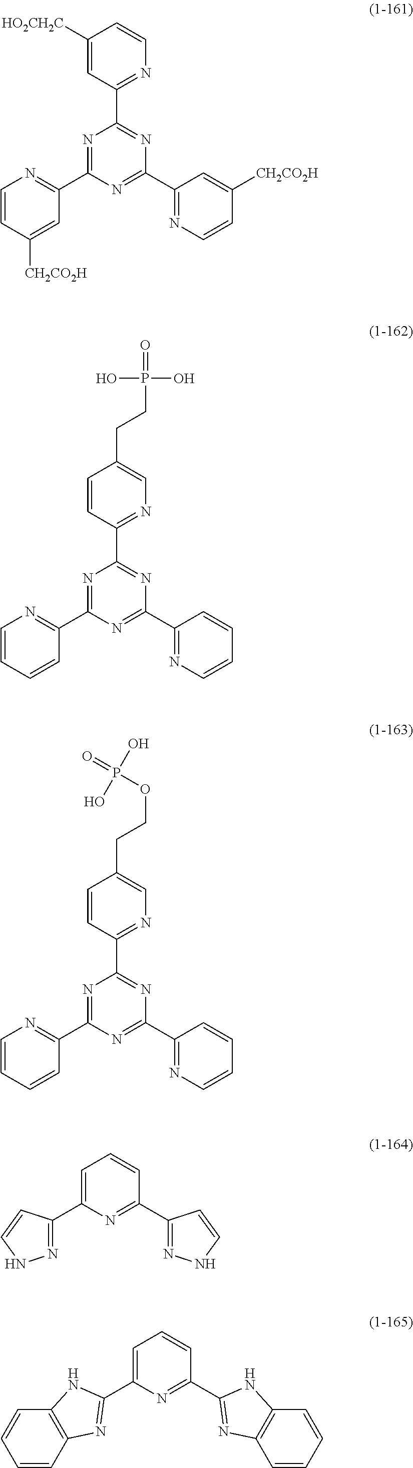

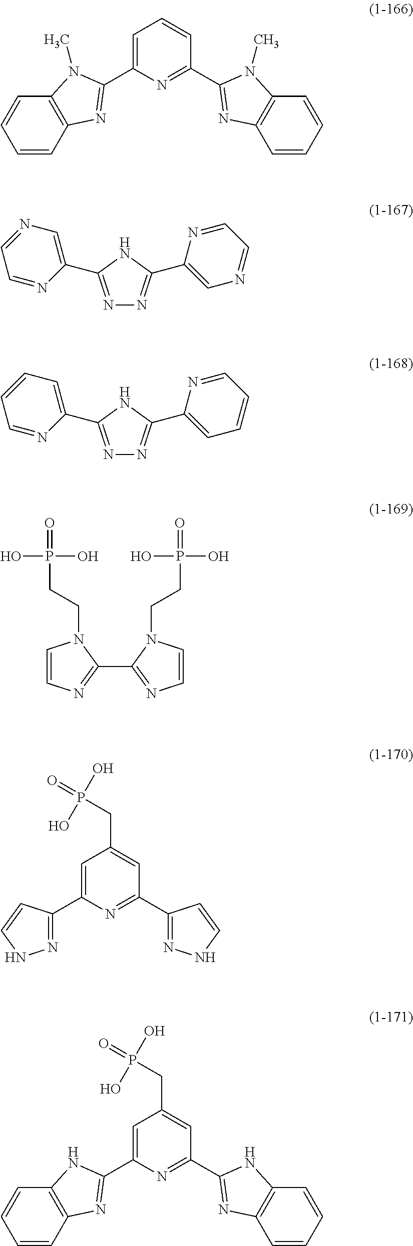

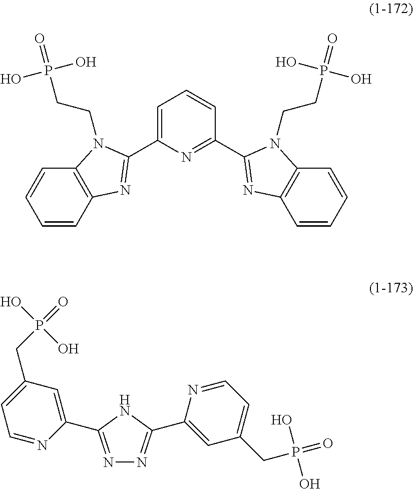

Next, examples of a metal complex coordinated with at least one organic ligand having a carbon-nitrogen double bond as the substructure will be shown below, however, the present invention is not limited thereto. In the table, M represents a center metal, L represents an organic ligand, n represents a number of the ligand and A represents a counter salt neutralizing the charge.

| | | L | | |
|---|---|---|---|---|
| Metal Complex No. | M | (Exemplified No.) | n | A |
| A-1 | Fe(II) | 1-147 | 3 | (ClO₄)₂ |
| A-2 | Fe(II) | 1-152 | 3 | (PF₆)₂ |
| A-3 | Fe(II) | 1-158 | 2 | (PF₆)₂ |
| A-4 | Fe(II) | 1-70 | 3 | I₂ |
| A-5 | Fe(II) | 1-37 | 3 | (ClO₄)₂ |
| A-6 | Fe(II) | 1-102 | 3 | (PF₆)₂ |
| A-7 | Fe(II) | 1-116 | 3 | SO₄ |
| A-8 | Fe(II) | 1-119 | 3 | SO₄ |
| A-9 | Fe(II) | 1-24 | 2 | (PF₆)₂ |
| A-10 | Fe(II) | 1-131 | 2 | (PF₆)₂ |
| A-11 | Fe(II) | 1-146 | 3 | (BF₄)₂ |
| A-12 | Ru(II) | 1-1 | 3 | C1₂ |
| A-13 | Ru(II) | 1-94 | 3 | (PF₆)₂ |
| A-14 | Co(II) | 1-41 | 3 | (ClO₄)₂ |
| A-15 | Ni(II) | 1-20 | 3 | (ClO₄)₂ |

The preferably usable other electrochromic compounds include the compounds represented by Formula (A).

The electrochromic compounds preferably usable in the present invention represented by Formula (A) will be detailed.

In Formula (A), R₁ represents a substituted or unsubstituted aryl group, and R₂ and R₃ each represent a hydrogen atom or a substituent Specific examples of the substituents represented by R₁, R₂ and R₃ include an alkyl group (for example, a methyl group, an ethyl group, a propyl group, an isopropyl group, a tert-butyl group, a pentyl group, or a hexyl group), a cycloalkyl group (for example, a cyclohexyl or a cyclopentyl group), an alkenyl group, a cycloalkenyl group, an alkynyl group (for example, a propargyl group), a glycidyl group, an acrylate group, a methacrylate group, an aromatic group (for example, a phenyl group, a naphthyl group, or an anthracenyl group), a heterocyclic group (for example, a pyridyl group, a thiazolyl group, an oxazolyl group, an imidazolyl group, a furyl group, a pyrrolyl group, a pyrazinyl group, a pyrimidinyl group, a pyridazinyl group, a selenazolyl group, a sulfolanyl group, a piperidinyl group, a pyrazolyl group, or a tetrazolyl group), an alkoxy group (for example, a methoxy group, an ethoxy group, a propyloxy group, a pentyloxy group, a cyclopentyloxy group, a hexyloxy group, or a cyclohexyloxy group), an aryloxy group (for example, a phenoxy group), an alkoxycarbonyl group (for example, a methyloxycarbonyl group, an ethyloxycarbonyl group, or a butyloxycarbonyl group), an aryloxycarbonyl group (for example, a phenyloxycarbonyl group), a sulfonamide group (for example, a methane sulfonamide group, an ethane sulfonamide group, a butane sulfonamide group, a hexane sulfonamide group, a cyclohexane sulfonamide group, or a benzene sulfonamide group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, a phenylaminosulfonyl group, or a 2-pyridylaminosulfonyl group), an urethane group (for example, a methylureide group, an ethylureide group, a pentylureide group, a cyclohexylureide group, a phenylureide, or a 2-pyridylureide), an acyl group (for example, an acetyl group, a propionyl group, a butanoyl group, a hexanoyl group, a cyclohexanoyl group, a benzoyl group, or a pyridinoyl group), a carbamoyl group (for example, an aminocarbamoyl group, a methylamino carbamoyl group, a dimethyl aminocarbamoyl group, a propyl aminocarbamoyl group, a pentyl aminocarbamoyl group, a cyclohexyl aminocarbamoyl group, a phenylamino carbamoyl group, or 2-pyridylaminocarbamoyl group), an acylamino group (for example, an acetylamino group, a benzoylamino group, or a methylureide group), an amide group (for example, an acetamide group, a propioneamide group, a butaneamide, a hexaneamide, or a benzamide group), a sulfonyl group (for example, a methylsulfonyl group, an ethylsulfonyl group, a butylsulfonyl group, a cyclohexylsulfonyl group a phenylsulfonyl group, or a 2-pyridylsulfonyl group), a sulfonamide (for example, a methylsulfonamide group, an octylsulfonamide group, a phenylsulfonamide group, or a naphthylsulfonamide group), an amino group (for example, an amino group, an ethylamino group, a dimethylamino group, a butylamino group, a cyclopentylamino group, an anilino group, or a 2-pyridylamino group), a halogen atom (for example, a chlorine atom, a bromine atom, a iodine atom), a cyano group, a nitro group, a sulfo group, a carboxyl group, a hydroxyl group, a phosphono group (for example, a phosphonoethyl group, a phosphonopropyl group, or a phosphonooxyethyl group), or an oxamoyl group. These substituents may be further substituted by any of them.

R₁ is a substituted or unsubstituted aryl group, and is preferably a substituted or unsubstituted phenyl group, more preferably a substituted or unsubstituted 2-hyroxyphenyl or 4-hyroxyphenyl groups.

R₂ and R₃ are preferably an alkyl group, a cycloalkyl group, an aromatic group, or a heterocyclic group; more preferably, one of R₂ and R₃ is a phenyl group, and the other is an alkyl group; and further more preferably, both of R₂ and R₃ are a phenyl group.

X is preferably >N—R₄. R₄ is preferably a hydrogen atom, an alkyl group, an aromatic group, a heterocyclic group, or an acyl group, and is more preferably a hydrogen atom, an alkyl group having 1 to 10 carbon atoms, an aryl group having 5 to 10 carbon atoms, or an acyl group.

Specific examples of the electrochromic compounds represented by Formula (A) will now be listed; however, the present invention is not limited only to the following example compounds.

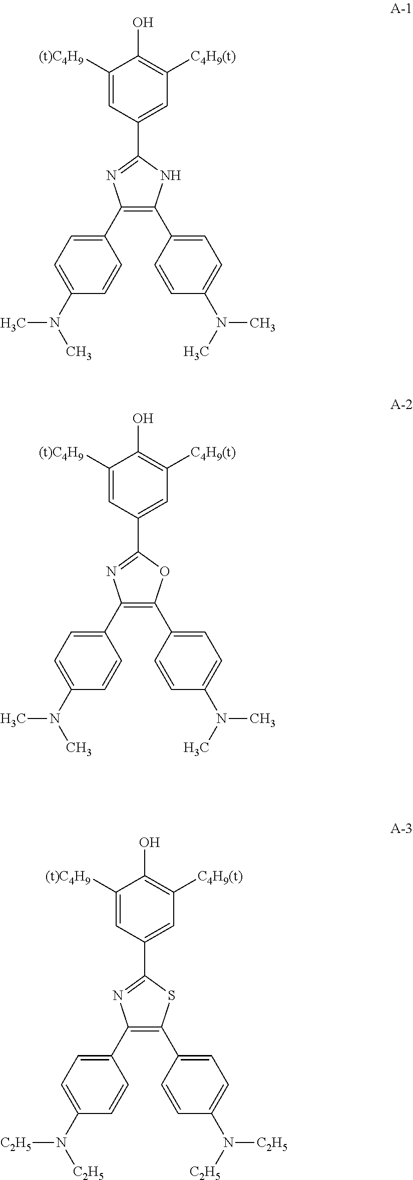

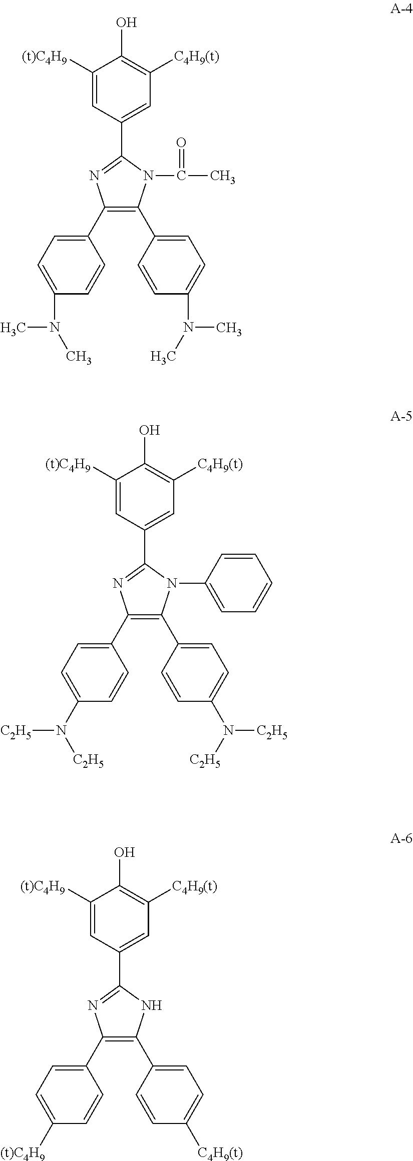

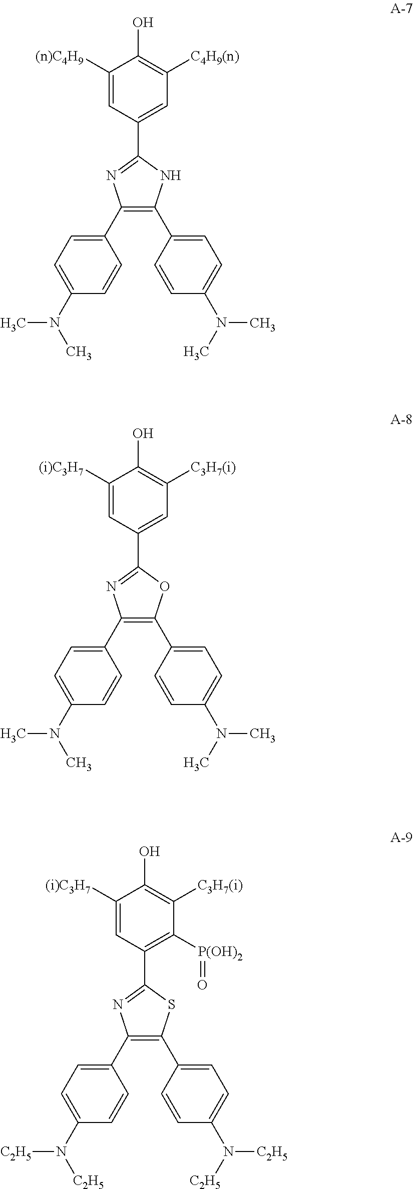

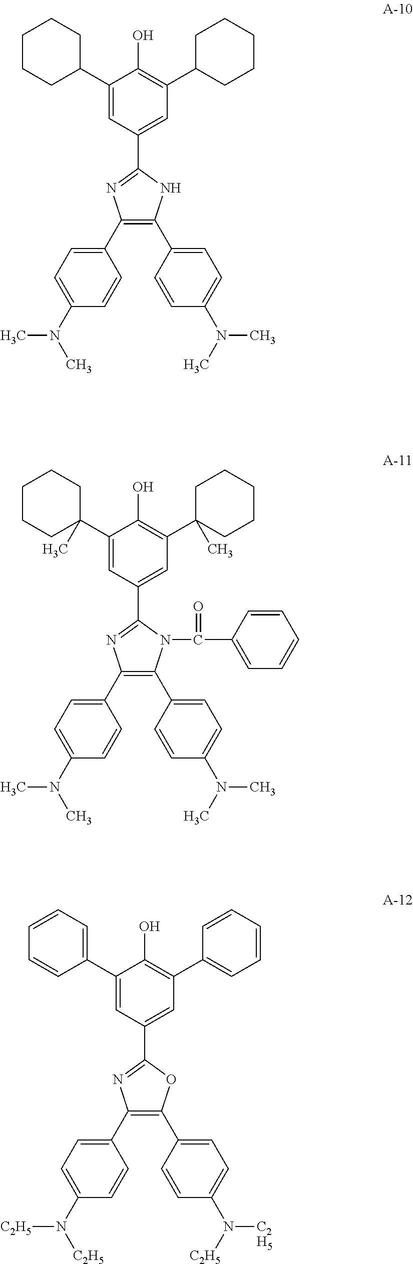

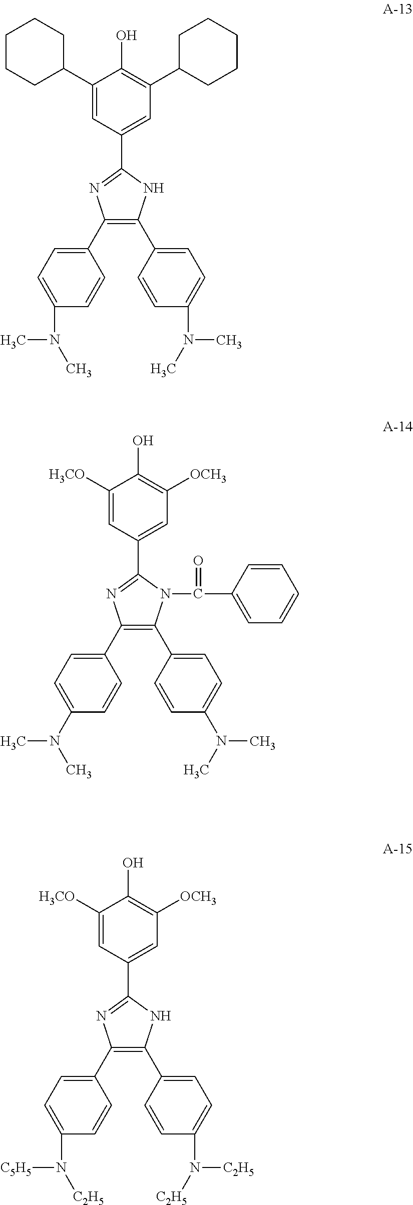

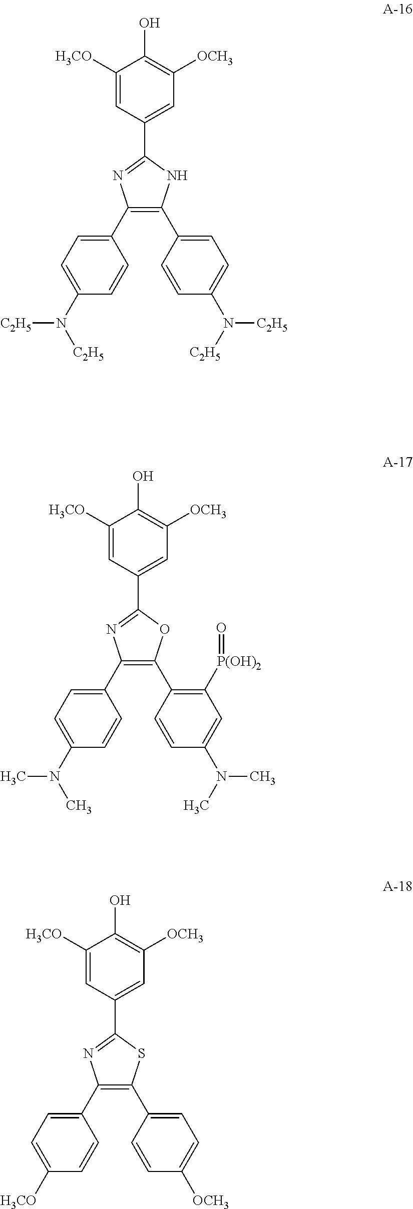

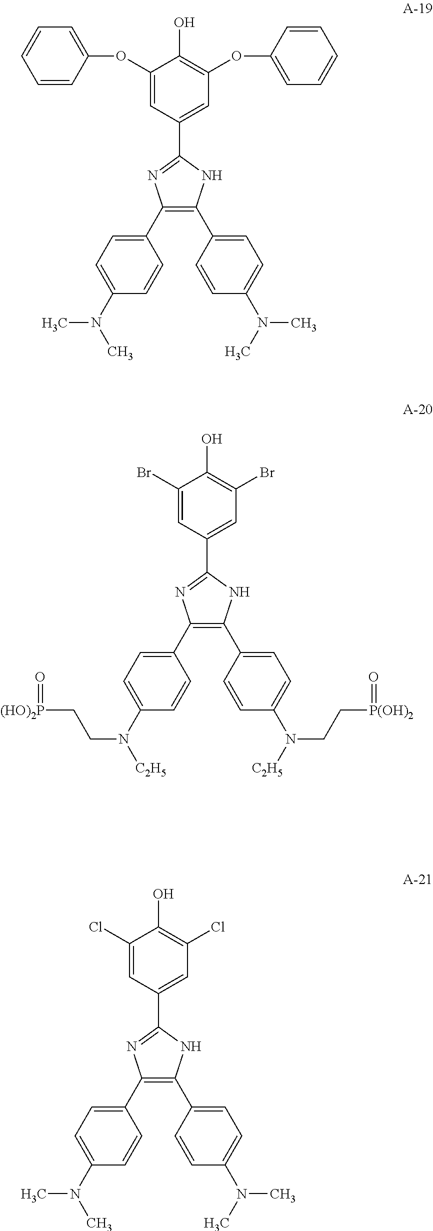

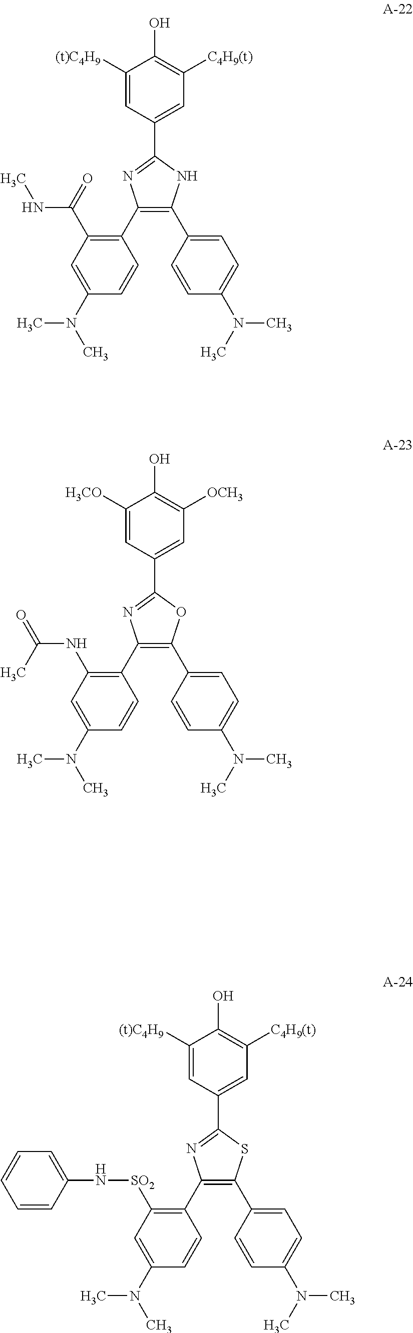

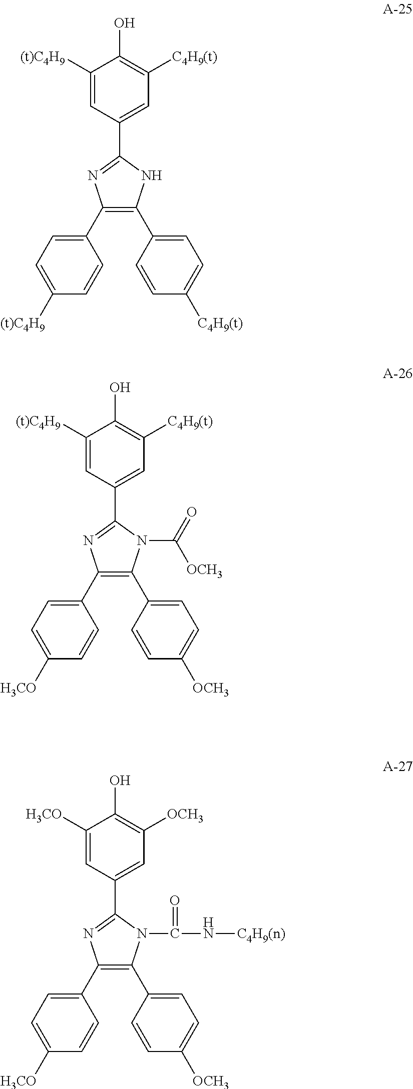

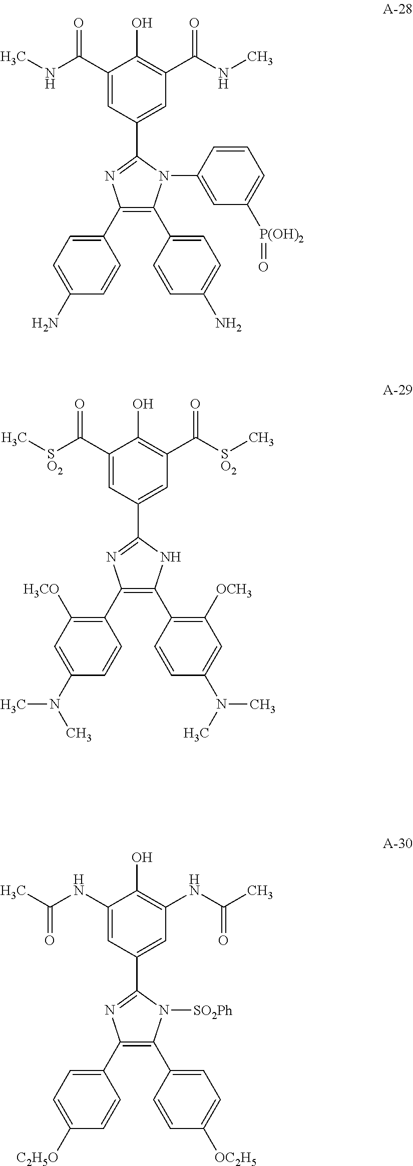

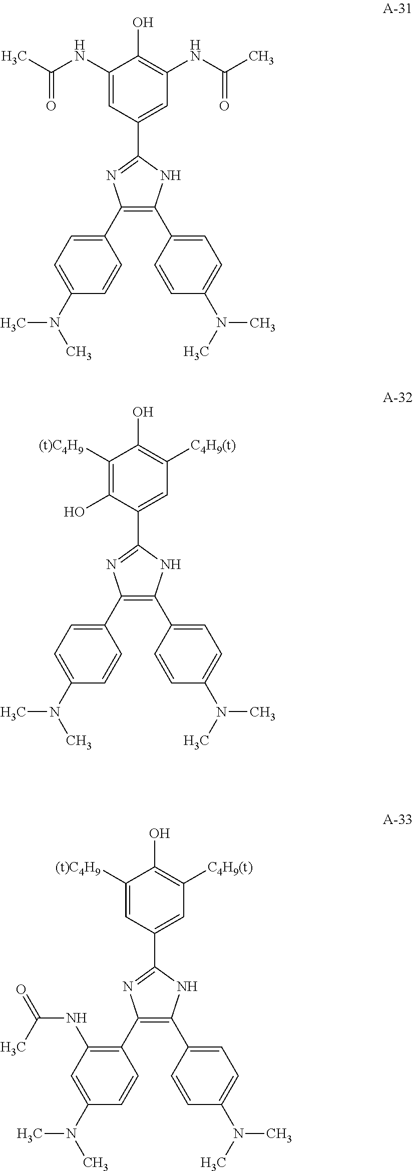

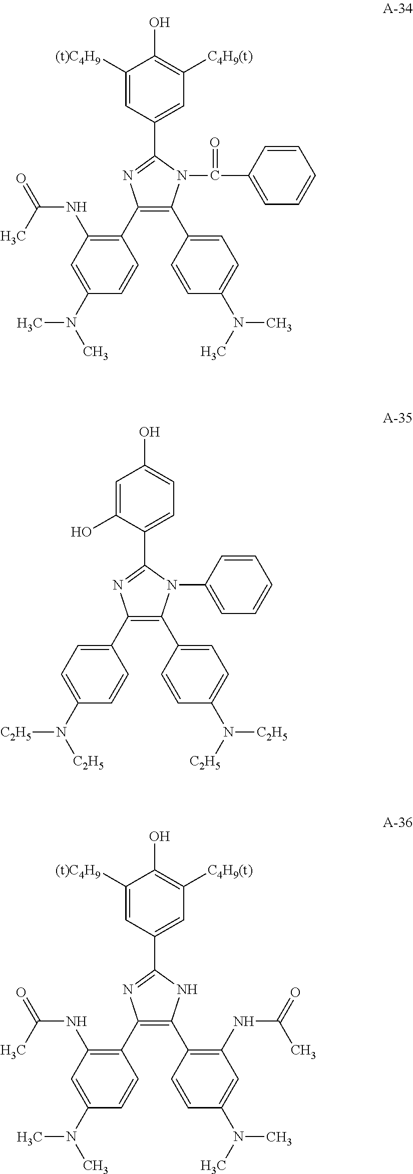

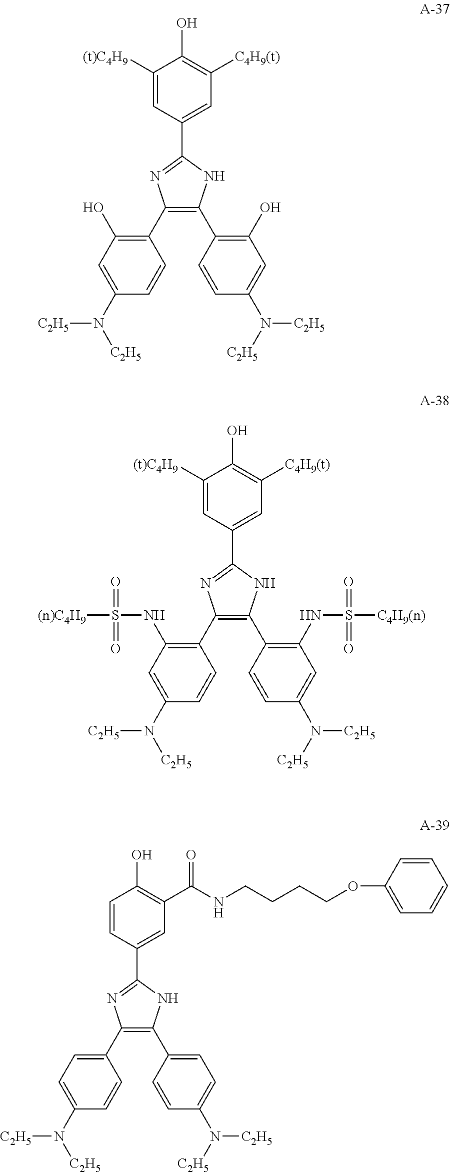

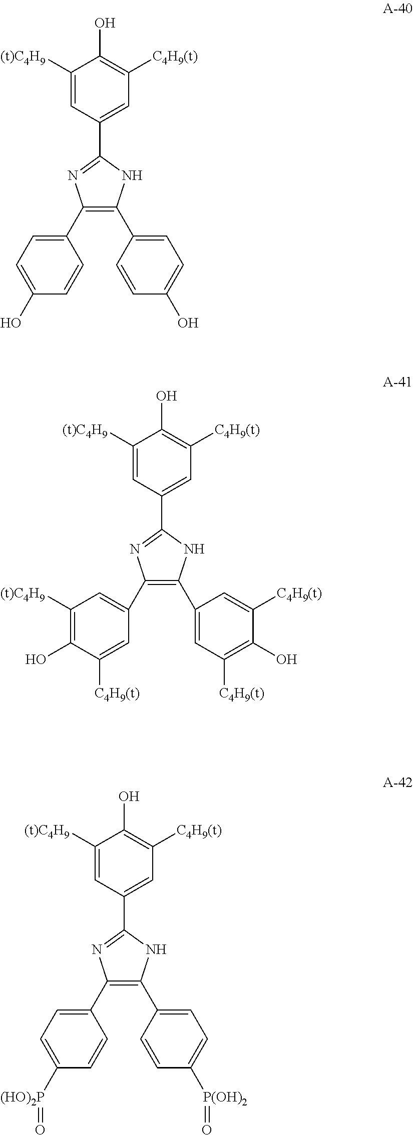

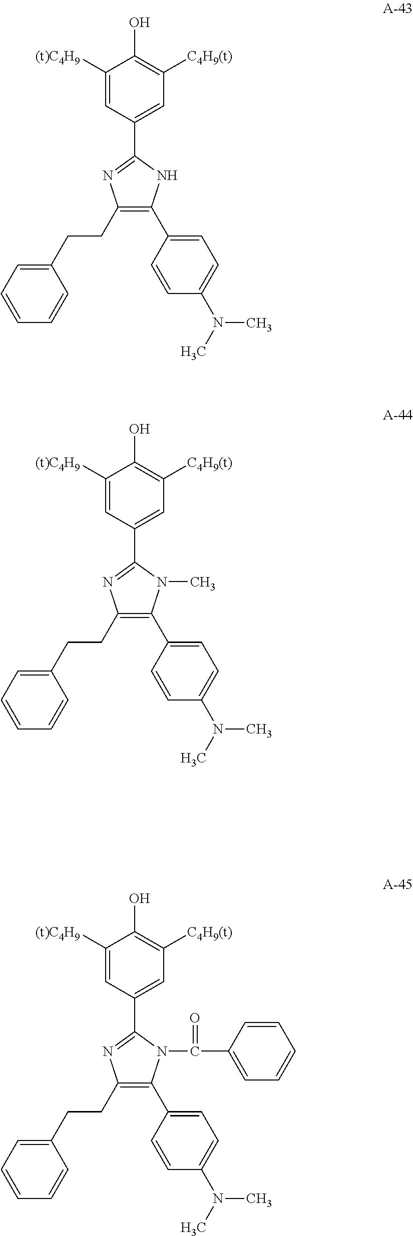

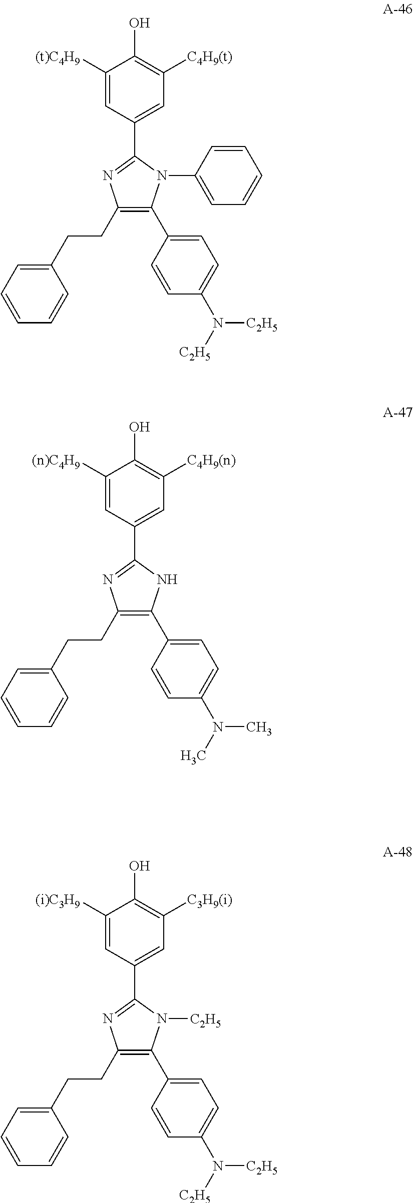

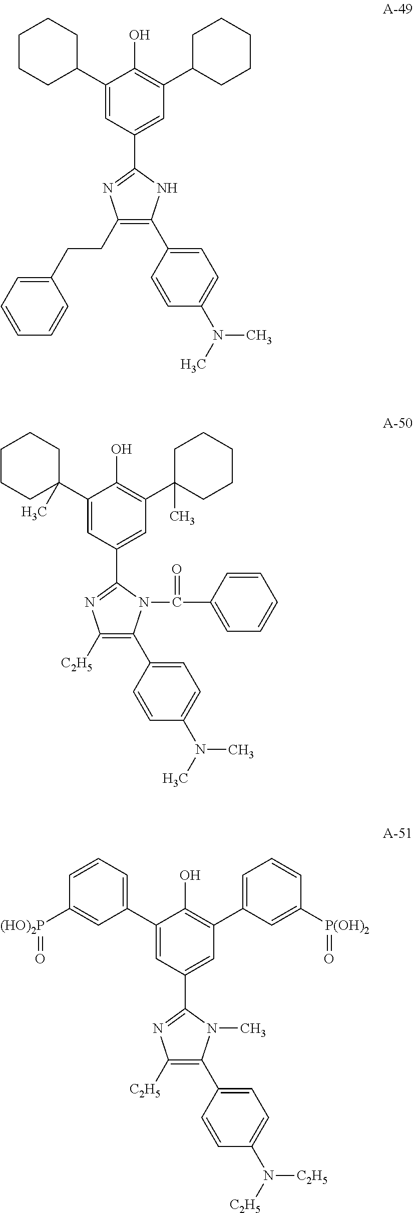

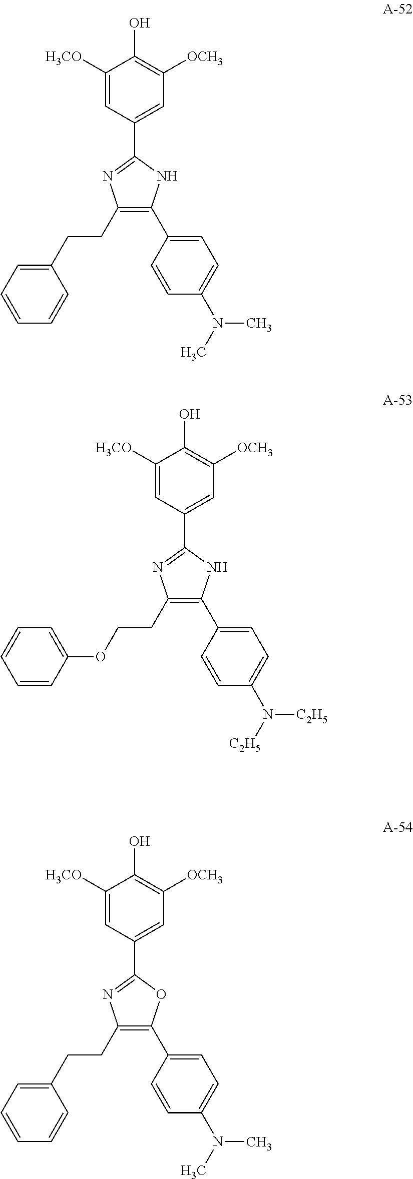

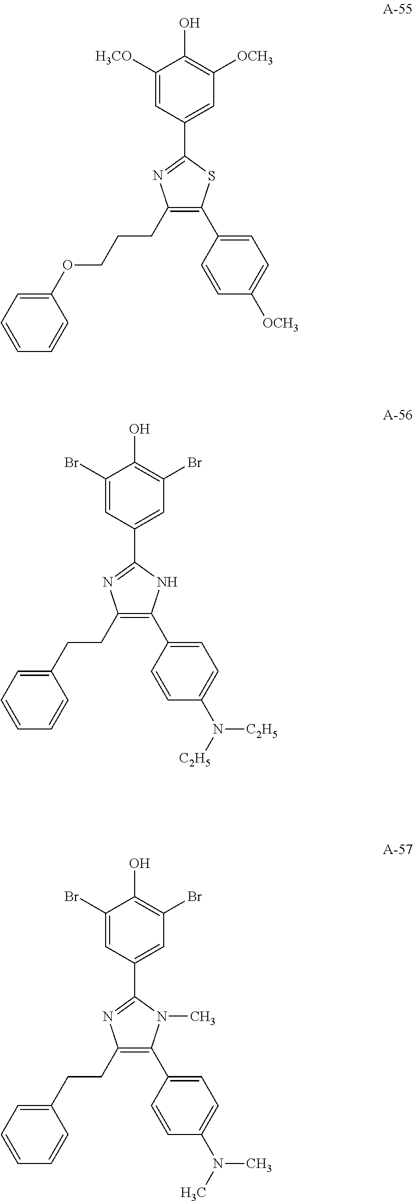

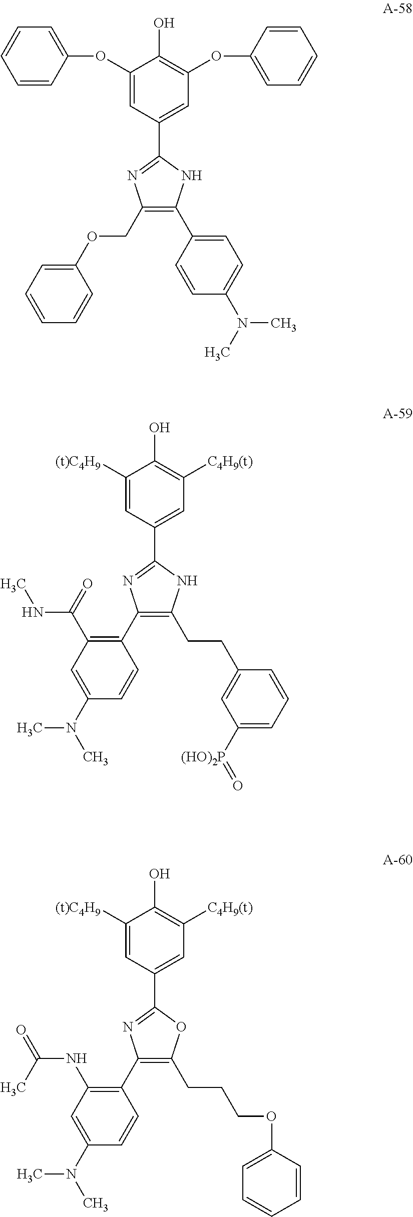

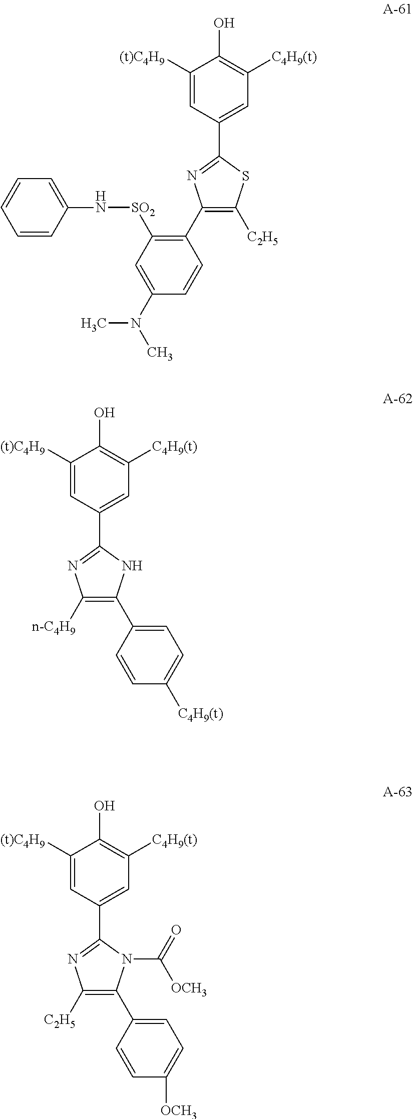

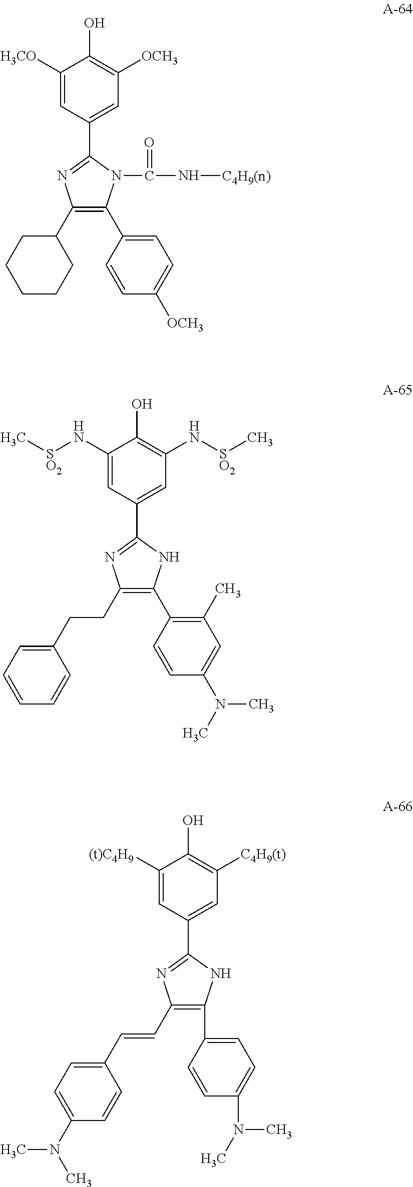

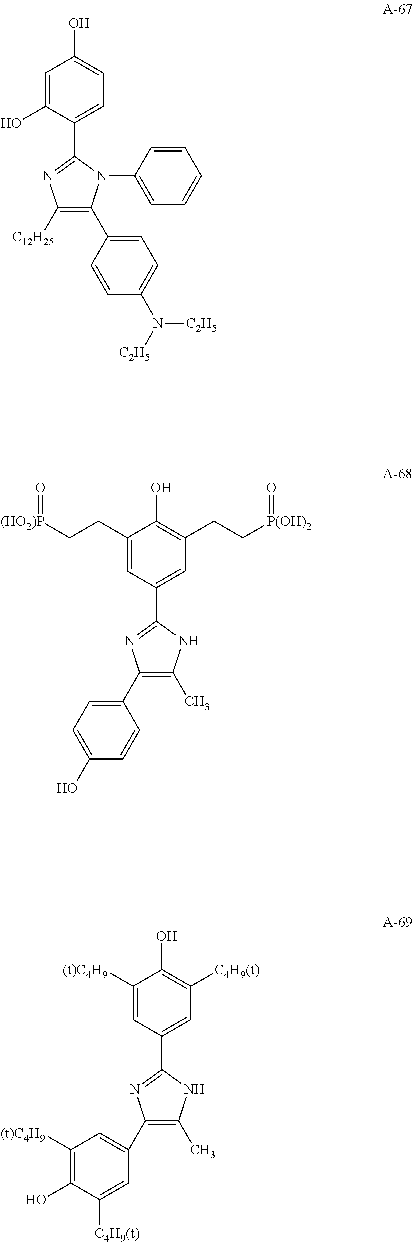

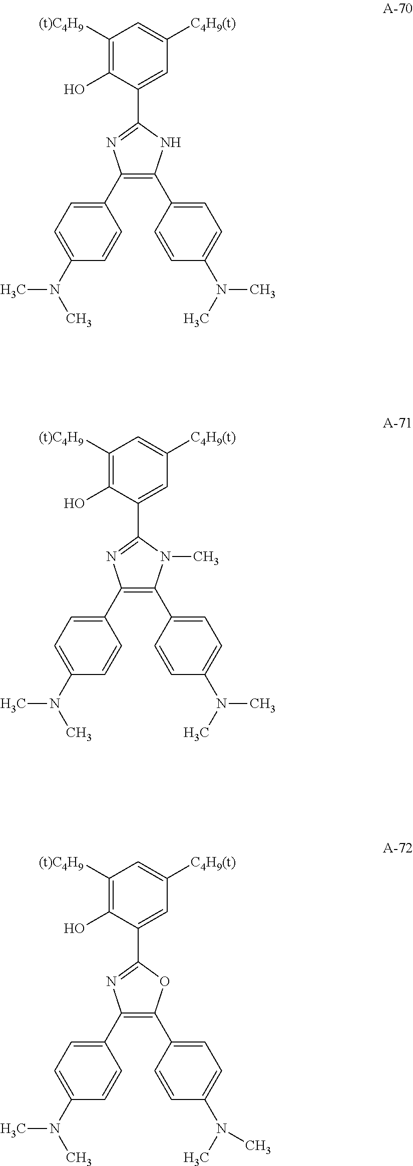

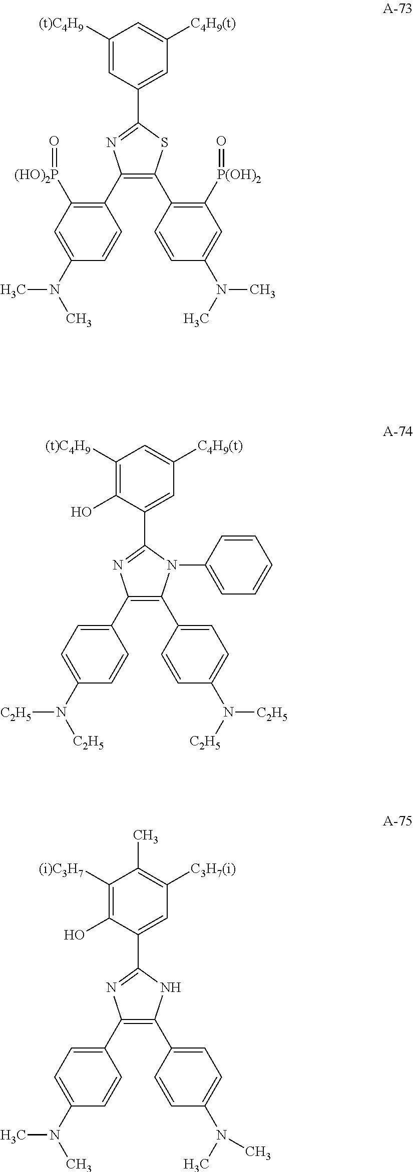

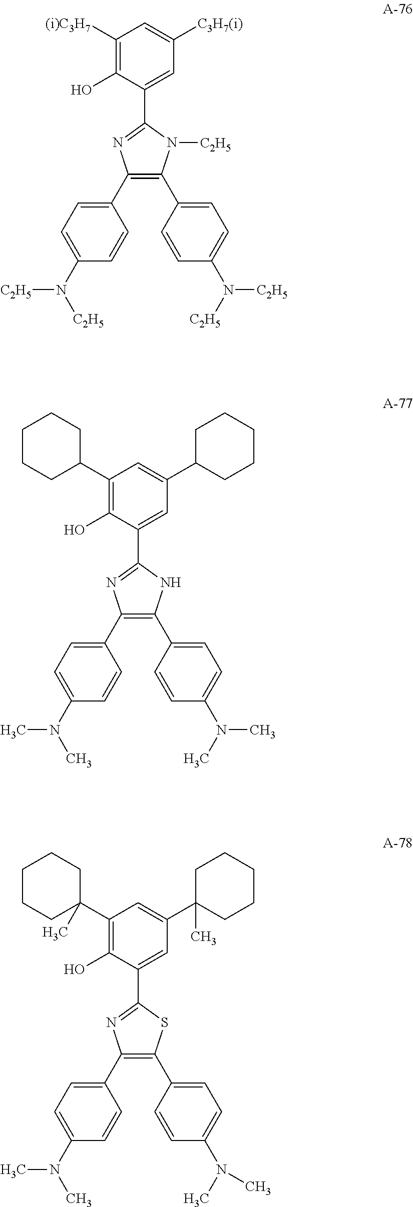

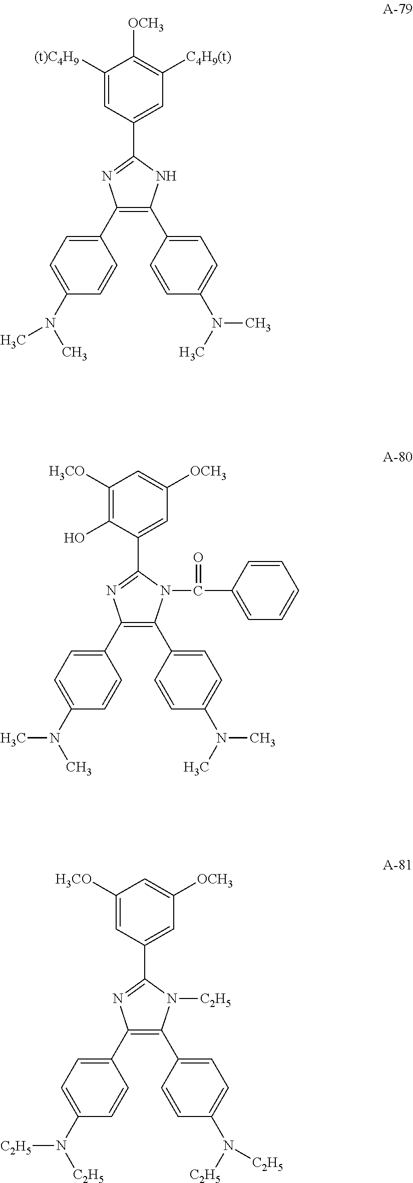

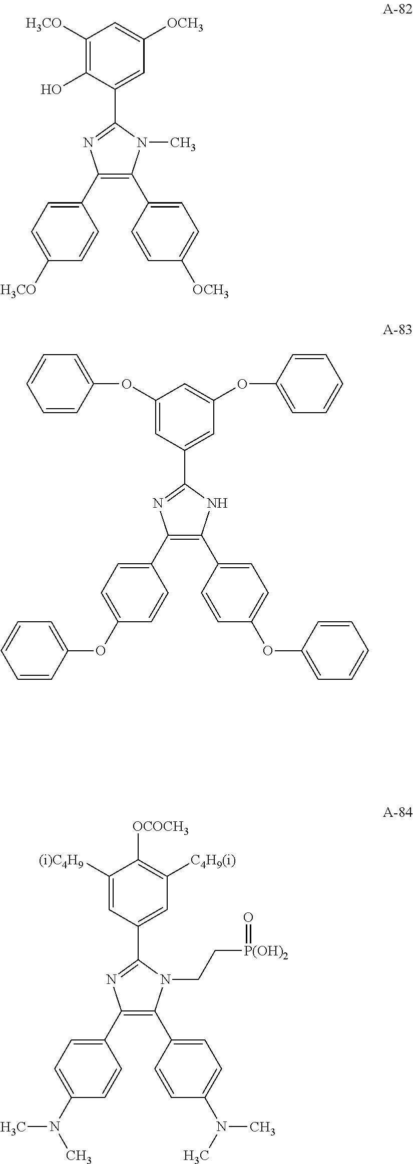

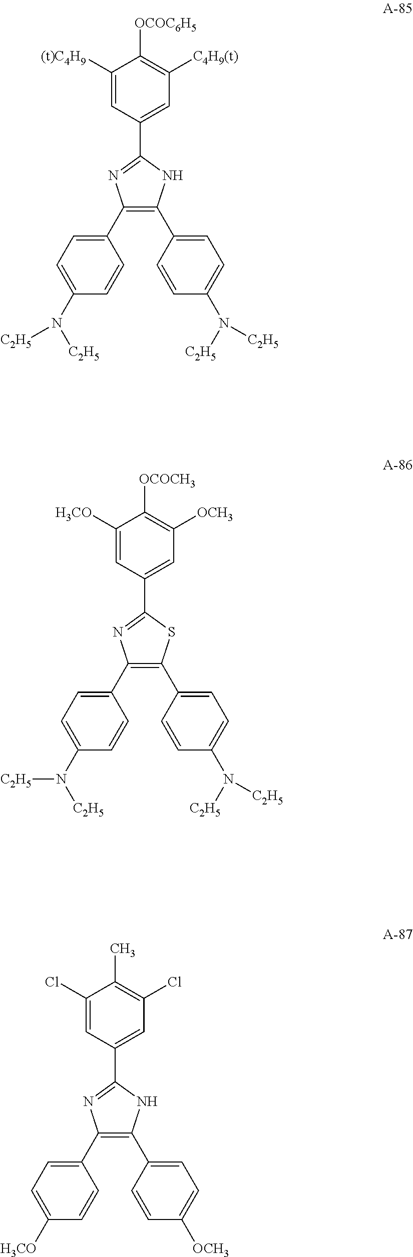

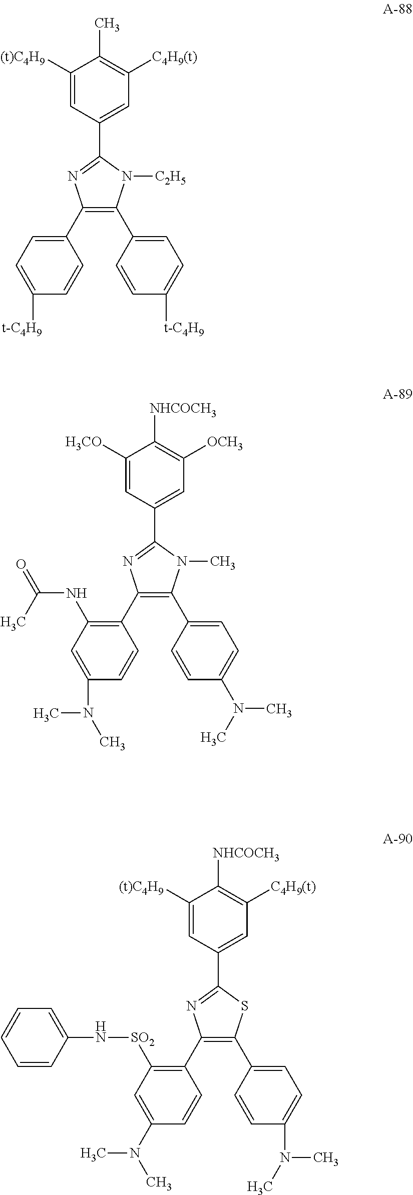

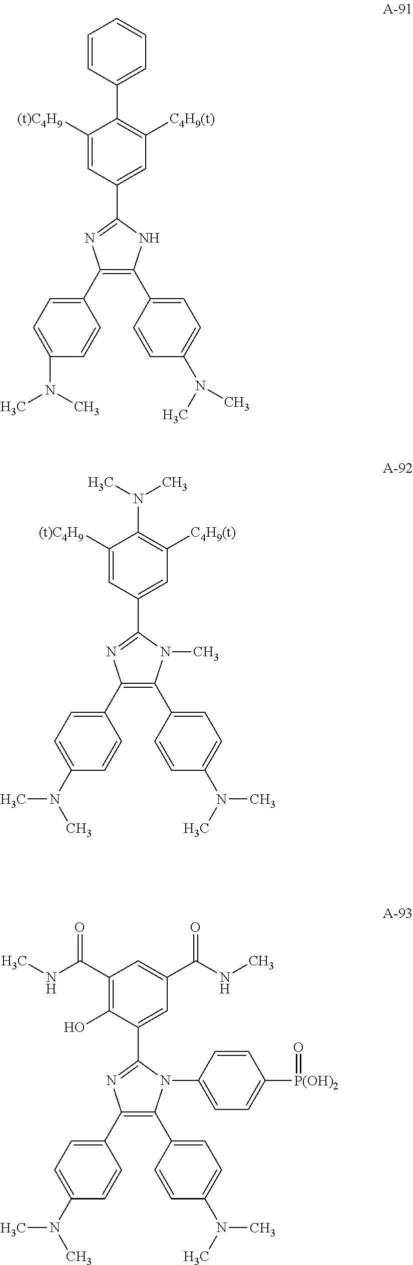

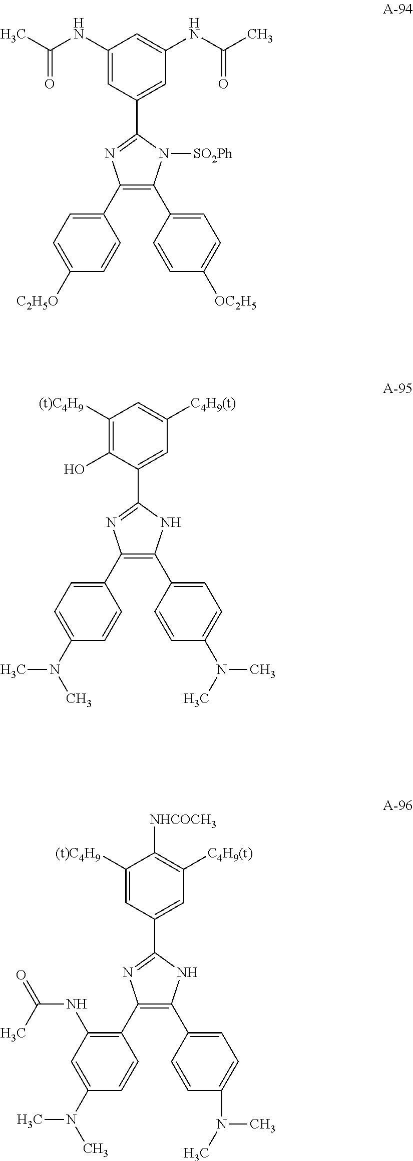

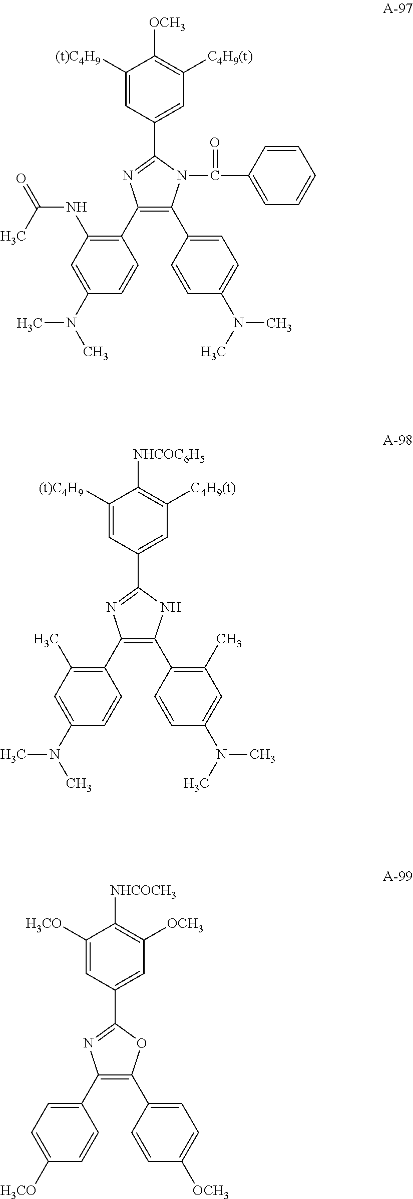

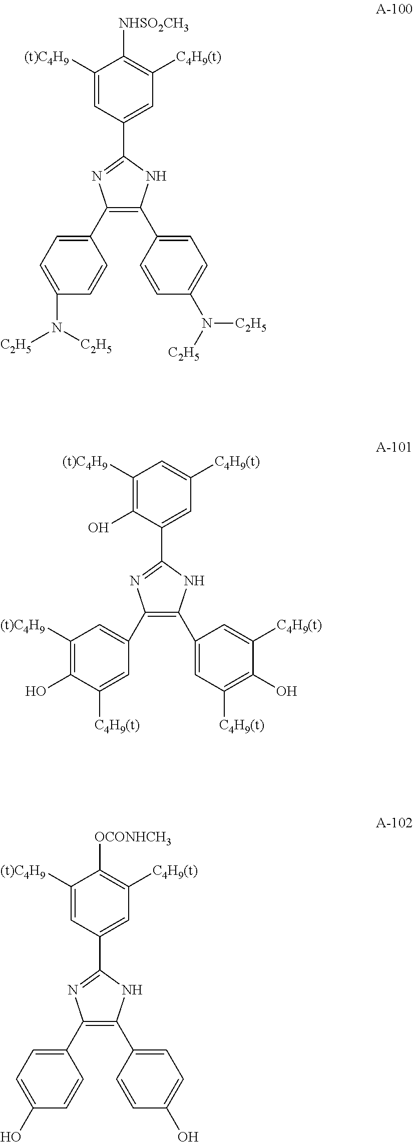

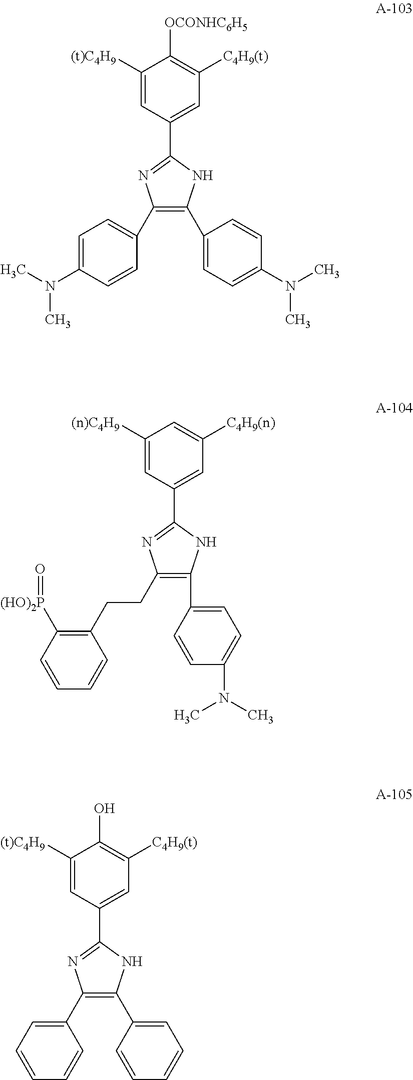

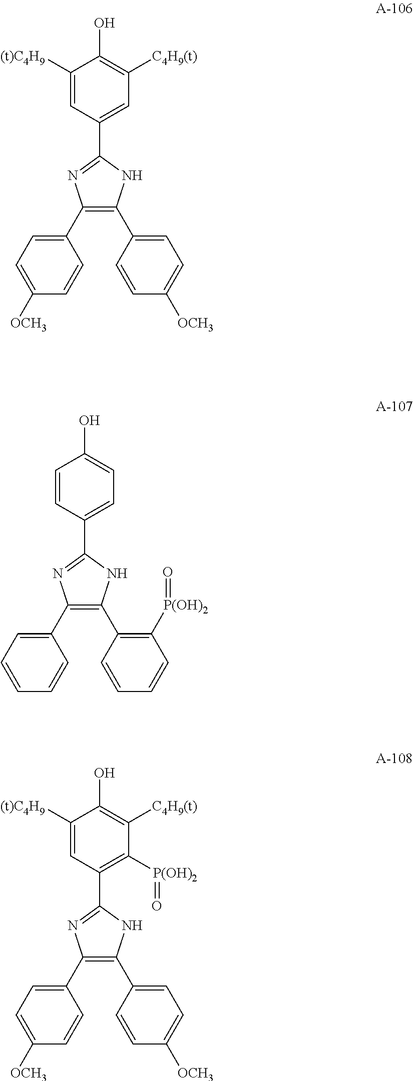

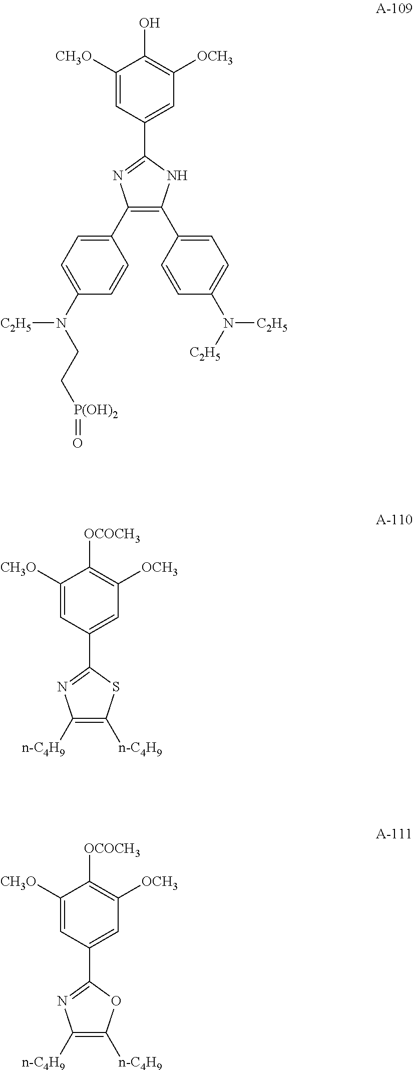

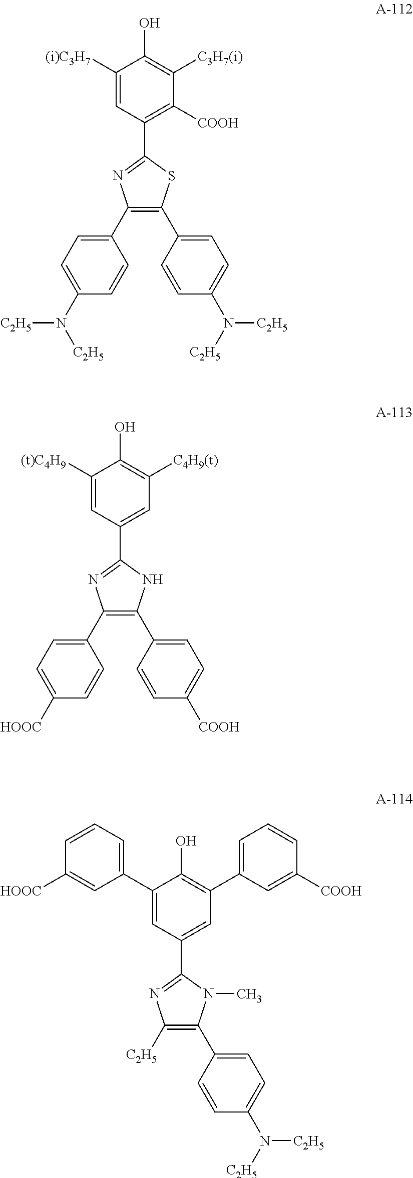

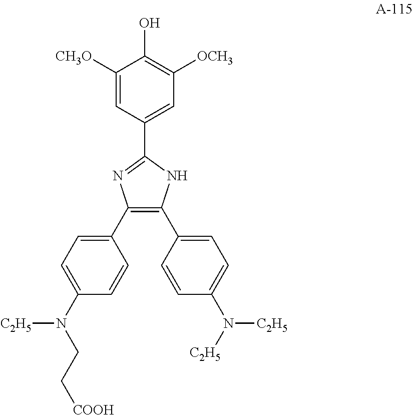

### (Metal Salt Compound)

The metal salt compounds, that are redox active compound according to the present invention and used preferably as the light control material, may be any salts including metals which can conduct dissolution and deposition repeatedly on at least one of the counter electrode by driving operation of the counter electrodes. Preferable metals include silver, bismuth, copper, nickel, iron, chromium, zinc and the like, and the more preferably silver and bismuth in view of black color tone and redox potential.

### (Silver Salt Compound)

It is preferable that the metal salt compound contained in the electrolyte is silver or a silver compound containing silver in the chemical structure. The silver or a silver compound containing silver in the chemical structure according to the present invention are generic term of the compounds such as silver oxide, silver sulfide, silver metal, silver colloid particles, silver halide, silver complex compound and silver ion, and include any phase such as solid state, solubility state in the liquid and gas state, charging state such as neutral, anionic, cationic or the like.

It is preferable the electrolyte layer contains at least one of compounds represented by Formula (1) or (2) when the metal salt compounds are used as a light control agent in the electrolyte of the photochromic display element of the present invention.

R₇—S—R₈ Formula (1)

in the formula, each of R₇ and R₈ represents a substituted or unsubstituted hydrocarbon group. R₇ and R₈ may form a ring by bonding each other. When a ring containing an S atom is formed, an aromatic group is not to be included.

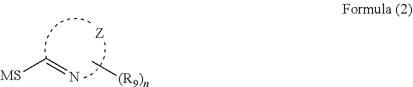

in the formula, M represents a hydrogen atom, a metal atom, or quaternary ammonium; Z represents a nitrogen-containing heterocyclic ring; n represents an integer of 0 to 5; R₉ represents a hydrogen atom, a halogen atom, an alkyl group, an aryl group, an alkylcarbonamido group, an arylcarbonamido group, an alkylsulfonamido group, an arylsulfonamido group, an alkoxy group, an aryloxy group, an alkylthio group, an arylthio group, an alkylcarbamoyl group, an arylcarbamoyl group, a carbamoyl group, an alkylsulfamoyl group, an arylsulfamoyl group, a sulfamoyl group, a cyano group, an alkylsulfonyl group, an arylsulfonyl group, an alkoxycarbonyl group, an aryloxycarbonyl group, an alkylcarbonyl group, an arylcarbonyl group, an acyloxy group, a carboxyl group, a carbonyl group, a sulfonyl group, an amino group, a hydroxyl group, or a heterocyclic group. When n is 2 or more, each R₉ may be the same or different and may be joined to form a condensed ring.

In above Formula (I), R₇ and R₈ each represent a substituted or unsubstituted hydrocarbon group, which includes a straight chain group or branched chain group. Further, these hydrocarbon groups may contain at least one of a nitrogen atom, an oxygen atom, a phosphorous atom, a sulfur atom, and a halogen atom. However, when a ring containing an S atom is formed, no aromatic group is employed. It is preferred that each of element neighboring to S atom is a carbon atom.

Listed as a substitutable group to the hydrocarbon group may, for example, be an amino group, a guanidino group, a quaternary ammonium group, a hydroxyl group, a halogen compound, a carboxyl group, a carboxylate group, an amido group, a sulfuric acid group, a sulfonic acid group, a sulfate group, a phosphonic acid group, a phosphate group, a nitro group, and a cyano group.

It is necessary to have silver solubilized in an electrolyte in order to result in dissolution and deposition of silver in general. Namely, it is common to employ a method in which silver or silver-containing compound is modified to be soluble compound via coexistence of a compound containing chemical structure species which result in mutual interaction with silver, which forms a coordination bond with silver or forms a weak covalent bond with silver. Known as the above chemical structure species are a halogen atom, a mercapto group, a carboxyl group, an imino group and so on. In the present invention, a thioether group also usefully acts as a silver solvent and exhibits features such as minimal effects to coexisting compounds and high solubility in solvents.

Specific examples of the compounds represented by Formula (I) according to the present invention will now be listed, however the present invention is not limited to the exemplified compounds.

### 1-1: CH₃SCH₂CH₂OH

### 1-2: HOCH₂CH₂SCH₂CH₂OH

### 1-3: HOCH₂CH₂SCH₂CH₂SCH₂CH₂OH

### 1-4: HOCH₂CH₂SCH₂CH₂SCH₂CH₂SCH₂CH₂OH

1-5: HOCH₂CH₂SCH₂CH₂OCH₂CH₂OCH₂CH₂SCH₂CH₂OH
1-6: HOCH₂CH₂OCH₂CH₂SCH₂CH₂SCH₂CH₂OCH₂CH₂OH

### 1-7: H₃CSCH₂CH₂COOH

### 1-8: HOOCCH₂SCH₂COOH

### 1-9: HOOCCH₂CH₂SCH₂CH₂COOH

### 1-10: HOOCCH₂SCH₂CH₂SCH₂COOH

### 1-11: HOOCCH₂SCH₂CH₂SCH₂CH₂SCH₂CH₂SCH₂COOH

1-12: HOOCCH₂CH₂SCH₂CH₂SCH₂CH(OH)CH₂SCH₂CH₂SCH₂CH₂COOH
1-13: HOOCCH₂CH₂SCH₂CH₂SCH₂CH(OH)CH(OH)CH₂SCH₂CH₂SCH₂CH₂COOH

### 1-14: H₃CSCH₂CH₂CH₂NH₂

### 1-15: H₂NCH₂CH₂SCH₂CH₂NH₂

### 1-16: H₂NCH₂CH₂SCH₂CH₂SCH₂CH₂NH₂

### 1-17: H₃CSCH₂CH₂CH(NH₂)COOH

1-18: H₂NCH₂CH₂OCH₂CH₂SCH₂CH₂SCH₂CH₂OCH₂CH₂NH₂
1-19: H₂NCH₂CH₂SCH₂CH₂OCH₂CH₂OCH₂CH₂SCH₂CH₂NH₂
1-20: H₂NCH₂CH₂SCH₂CH₂SCH₂CH₂SCH₂CH₂SCH₂CH₂NH₂

### 1-21: HOOC(NH₂)CHCH₂CH₂SCH₂CH₂SCH₂CH₂CH(NH₂)COOH

1-22: HOOC(NH₂)CHCH₂SCH₂CH₂OCH₂CH₂OCH₂CH₂SCH₂CH(NH₂)COOH
1-23: HOOC(NH₂)CHCH₂OCH₂CH₂SCH₂CH₂SCH₂CH₂OCH₂CH(NH₂)COOH
1-24: H₂N(O═)CCH₂SCH₂CH₂OCH₂CH₂OCH₂CH₂SCH₂C(═O)NH₂

### 1-25: H₂N(O═)CCH₂SCH₂CH₂SCH₂C(O═)NH₂

### 1-26: H₂NHN(O═)CCH₂SCH₂CH₂SCH₂C(═O)NHNH₂

### 1-27: H₃C(O═)NHCH₂CH₂SCH₂CH₂SCH₂CH₂NHC(═O)CH₃

1-28: H₂NO₂SCH₂CH₂SCH₂CH₂SCH₂CH₂SO₂NH₂
1-29: NaO₃SCH₂CH₂CH₂SCH₂CH₂SCH₂CH₂CH₂SO₃Na
1-30: H₃CSO₂NHCH₂CH₂SCH₂CH₂SCH₂CH₂NHO₂SCH₃

### 1-31: H₂N(NH)CSCH₂CH₂SC(NH)NH₂.2HBr

### 1-32: H₂N(NH)CSCH₂CH₂OCH₂CH₂OCH₂CH₂SC(NH)NH₂.2HCl

### 1-33: H₂N(NH)CNHCH₂CH₂SCH₂CH₂SCH₂CH₂NHC(NH)NH₂.2HBr

### 1-34: [(CH₃)₃NCH₂CH₂SCH₂CH₂SCH₂CH₂N(CH₃)₃]²⁺.2Cl⁻

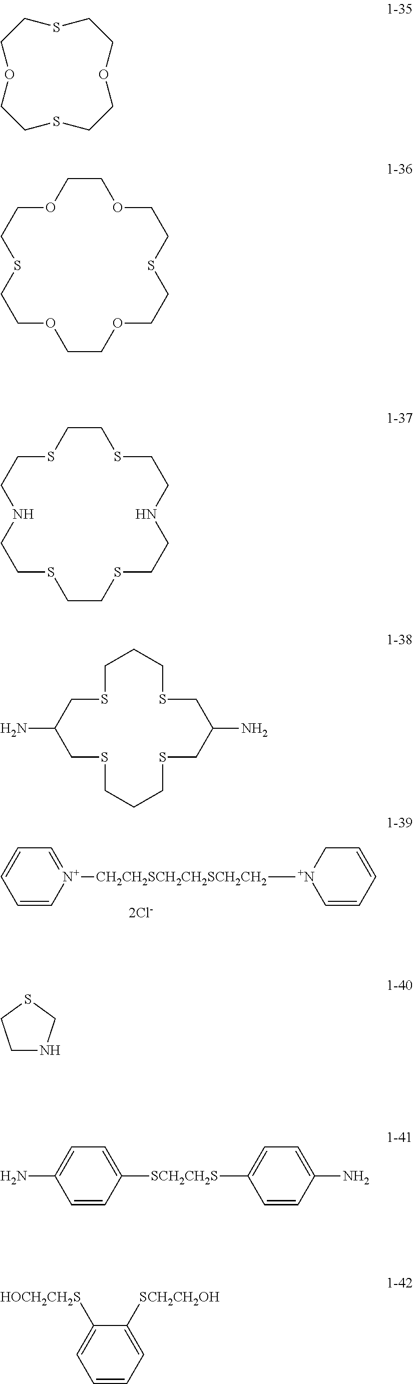

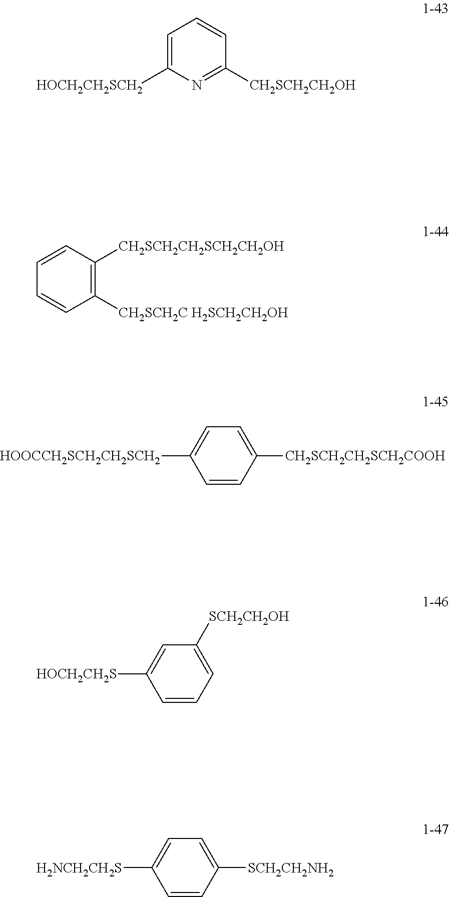

Compound 1-2 is specifically preferred among the above exemplified compounds in view of realizing the purposes and effects of the present invention.

The compounds represented by Formula (2) according to the present invention will now be described.

In above Formula (2), M represents a hydrogen atom metal atom or quaternary ammonium; Z represents a nitrogen-containing heterocyclic ring; n represents an integer of 0 to 5; R₉ represents a hydrogen atom, a halogen atom, an alkyl group, an aryl group, an alkylcarbonamido group, an arylcarbonamido group, an alkylsulfonamido group, an arylsulfonamido group, an alkoxy group, an aryloxy group, an alkylthio group, an arylthio group, an alkylcarbamoyl group, an arylcarbamoyl group, a carbamoyl group, an alkylsulfamoyl group, an arylsulfamoyl group, a sulfamoyl group, a cyano group, an alkylsulfonyl group, an arylsulfonyl group, an alkoxycarbonyl group, an aryloxycarbonyl group, an alkylcarbonyl group, an arylcarbonyl group, an acyloxy group, a carboxyl group, a carbonyl group, a sulfonyl group, an amino group, a hydroxyl group, or a heterocyclyl group. When n represent 2 or more, each R₉ may be the same or different, and may be joined to form a condensed ring.

Examples of metal atoms represented by M of Formula (2) include Li, Na, K, Mg, Ca, Zn, and Ag, and examples of quaternary ammonium include NH₄, (CH₃)₄N, (C₄H₉)₄N, (CH₃)₃NC₁₂H₂₅, (CH₃)₃NC₁₆H₃₃, and (CH₃)₃NCH₂C₆H₅.

Examples of the nitrogen-containing heterocyclic rings represented by Z of Formula (2) include a tetrazole ring, a triazole ring, an imidazole ring, an oxadiazole ring, a thiadiazole ring, an indole ring, an oxazole ring, a benzoxazole ring, a benzimidazole ring, a benzothiazole ring, a benzoselenazole ring, and a naphthoxazole ring.

Examples of the halogen atoms represented by R₉ of Formula (2) include a fluorine atom, a chlorine atom, a bromine atom and a iodine atom; examples of the alkyl groups include a methyl group, an ethyl group, a propyl group, an i-propyl group, a butyl group, a t-butyl group, a pentyl group, a cyclopentyl group, a hexyl group, a cyclohexyl group, an octyl group, a dodecyl group, a hydroxyethyl group, a methoxyethyl group, a trifluoromethyl group, and a benzyl group; examples of the aryl group include a phenyl group and a naphthyl group; examples of the alkylcarbonamido group include an acetylamino group, a propionylamino group, and a butyroylamino group; examples of the arylcarbonamido group include a benzoylamino group; examples of the alkylsulfonamido group include a methanesulfonylamino group and an ethanesulfonylamino group; examples of the arylsulfonamido group include a benzenesulfonylamino group and a toluenesulfonylamino group; examples of the aryloxy group include a phenoxy group; examples of the alkylthio group include a methylthio group, an ethylthio group, and a butylthio group; examples of the arylthio group include a phenylthio group and a tolylthio group; examples of the alkylcarbamoyl group include a methylcarbamoyl group, a dimethylcarbamoyl group, an ethylcarbamoyl group, a diethylcarbamoyl group, a dibutylcarbamoyl group, a piperidylcarbamoyl group, and a morphorylcarbamoyl group; examples of the arylcarbamoyl group include a phenylcarbamoyl group, a methylphenylcarbamoyl group, an ethylphenylcarbamoyl group, and a benzylphenylcarbamoyl group; examples of the alkylsulfamoyl group include a methylsulfamoyl group, a dimethylsulfamoyl group, an ethylsulfamoyl group, a diethylsulfamoyl group, a dibutylsulfamoyl group, a piperidylsulfamoyl group, and a morphorylsulfamoyl group; examples of the arylsulfamoyl group include a phenylsulfamoyl group, a ethylphenylsulfamoyl group, an ethylphenylsulfamoyl group, and a benzylphenylsulfamoyl group; examples of the alkylsulfonyl group include a methanesulfonyl group and an ethanesulfonyl group; examples of the arylsulfonyl group include a phenylsulfonyl group, a 4-chlorophenylsulfonyl group, and a p-toluenesulfonyl group; examples of the alkoxycarbonyl group include a methoxycarbonyl group, an ethoxycarbonyl group, and a butoxycarbonyl group; examples of the aryloxycarbonyl group include a phenoxycarbonyl group; examples of the alkylcarbonyl group include an acetyl group, a propionyl group, and a butyroyl group; examples of the arylcarbonyl group include a benzoyl group and an alkylbenzoyl group; examples of the acyloxy group include an acetyloxy group, a propionyloxy group, and a butyroyloxy group; examples of the heterocyclyl group include an oxazole ring, a thiazole ring, a triazole ring, a selenazole ring, a tetrazole ring, an oxadiazole ring, a thiadiazole ring, a thiazine ring, a triazine ring, a benzoxazole ring, a benzothiazole ring, an indolenine ring, a benzoselenazole ring, a naphthothiazole ring, a triazaindolizine ring, a diazaindolizine ring, and a tetraazaindolizine ring. These substituents include those which have a substituent.

Specific examples of the preferred compounds represented by Formula (2) will now be cited, however the present invention is not limited these compounds.

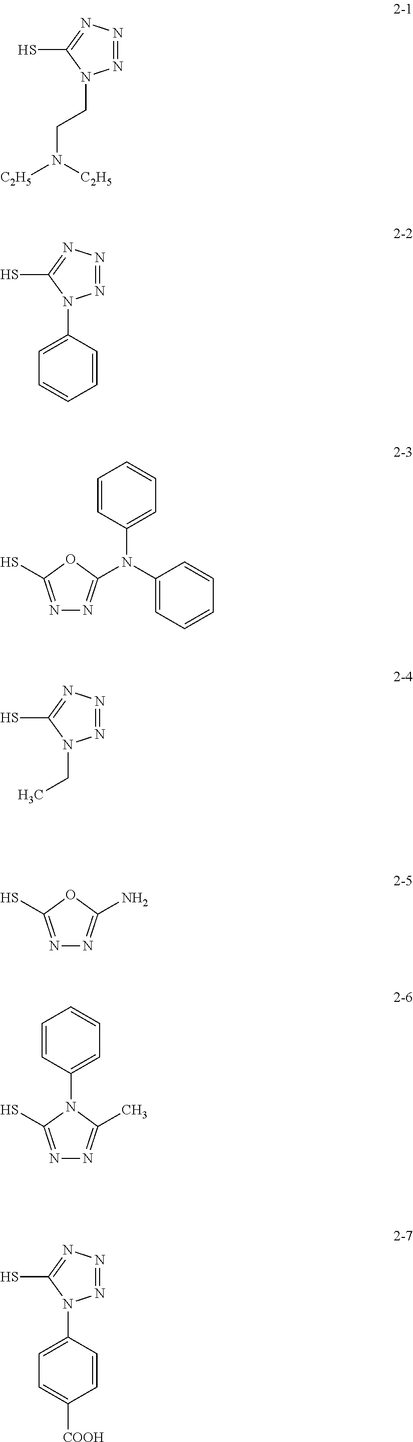

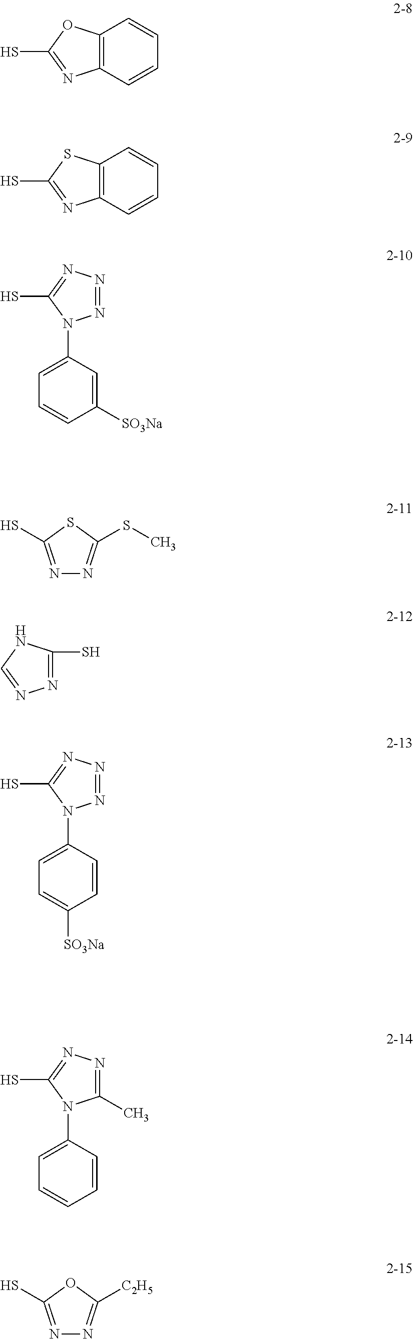

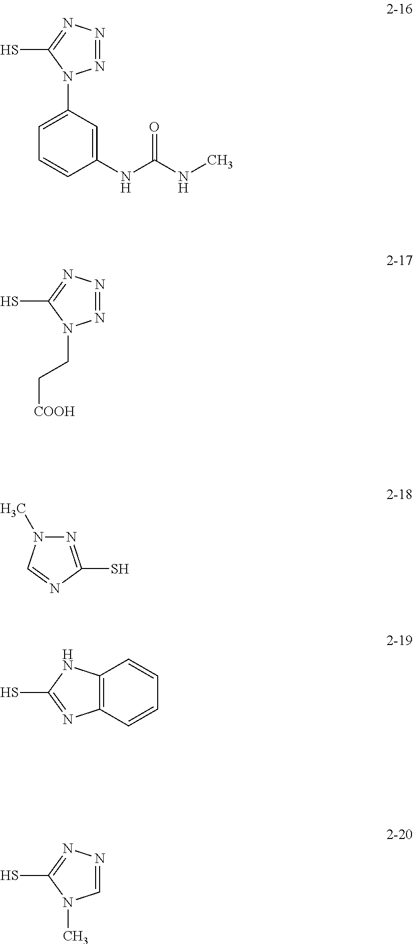

Specifically preferred are Exemplified Compounds 2-12, 2-18 2-20 among the compounds exemplified as above, in view of satisfactorily realizing the objects and effects of the present invention.

### (Concentration Ratio of Halogen Ion and Silver Ion)

It is preferable to satisfy the conditions specified by following Formula (I) in the display element of the present invention, wherein [X] represents mol concentration (mol/kg) of halogen ions or halogen atoms contained in the above electrolyte, and [M] represents total mol concentration (mol/kg) of metal ion of a metal containing compound in the chemical structure, contained in the aforesaid electrolyte.

0≦[X]/[M]≦0.01 Formula (1)

Halogen atoms, as described in the present invention refer to any of the iodine, chloride, bromine, and fluorine atoms. When [X]/[M] is at least 0.01, during oxidation-reduction reaction of silver, X⁻→X₂ occurs. This reaction becomes one of the factors in which X₂ easily undergoes cross oxidation with blackened silver to dissolve blackened silver, resulting in a decrease in memory capability. Consequently, it is preferable that the mol concentration of halogen atoms is as low as possible with respect to the mol concentration of silver. In the present invention, 0≦[X]/[M]≦0.001 is more preferred. When halogen ions are added, in view of enhancement of memory capability, the sum of mol concentration of each of the halogen species is [I]<[Br]<[Cl]<[F].

In the electrolyte layer of the present invention, organic solvent can be used in combination. Examples of such a solvent include: propylene carbonate, ethylene carbonate, γ-butyrolactone, tetramethylurea, sulfolane, dimethyl sulfoxide, 1,3-dimethyl-2-imidazolidinone, 2-(N-methyl)-2-pyrrolidinone, hexamethyl phosphoryltriamide, N-methyl propione amide, N,N-dimethylacetamide, N-methylacetamide, N,N-dimethylformamide, N-methylformamide, butyronitrile, propionitrile, acetonitrile, acetylacetone, 4-methyl-2-pentanone, 2-butanol, 1-butanol, 2-propanol, 1-propanol, ethanol, methanol, acetic anhydride, ethylacetate, ethylpropionate, dimethoxyethane, diethoxyfuran, tetrahydrofuran, ethylene glycol, diethylene glycol, triethylene glycol monobutyl ether and water. It is preferable that, among these solvents, at least one solvent having a freezing point of −20° C. or lower and a boiling point of 120° C. or more is incorporated.

Further listed as usable solvents in the present invention may be the compounds described in J. A. Riddick, W. B. Bunger, T. K. Sakano, “Organic Solvents”, 4th ed., John Wiley & Sons (1986), Y. Marcus, “Ion Solvation”, John Wiley & Sons (1985), C. Reichardt, “Solvents and Solvent Effects in Chemistry”, 2nd ed., VCH (1988), G. J. Janz, R. P. T. Tomkins, “Nonaqueous Electrolytes Handbook”, Vol. 1, Academic Press (1972). The electrolyte solvent may be a single variety or a solvent mixture.

It is preferred that the electrolyte layer does not substantially contain a volatile solvent. Examples of the organic solvent include various ionic liquid, phthalates having eight or more carbon atoms, aliphatic esters, sorbitols or the like.

### (Electrolyte—Silver Salt)

In the display element of the present invention, employed may be known silver compounds such as silver iodide, silver chloride, silver bromide, silver oxide, silver sulfide, silver citrate, silver acetate, silver behenate, silver trifluoromethane sulfonate, silver p-toluenesulfonate, silver salts of mercapto compounds, and silver complexes of iminodiacetic acids. Of these, it is preferable to employ silver salts which have no nitrogen atom exhibiting coordination capability with halogen, carboxylic acid, and silver, and for example, preferred is silver p-toluenesulfonate.

Silver ion concentration in the electrolyte according to the present invention is preferably 0.2 mol/kg≦[Ag]≦2.0 mol/kg. When the silver ion concentration is at most 0.2 mol/kg, a diluted silver solution is formed to lower the driving rate, while when it exceeds 2 mol/kg, solubility is degraded to tend to result in inconvenience of deposition during storage at low temperature and is disadvantageous.

Various constitution layers can be provided further to the constitution elements described above in the display element of the present invention.

In the display element of the present invention, there may be used thickening agents in the electrolyte layer. Examples thereof include gelatin, gum Arabic, poly(vinyl alcohol), hydroxyethyl cellulose, hydroxypropyl cellulose, cellulose acetate, cellulose acetate butyrate, poly(vinylpyrrolidone), poly(alkylene glycol), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinyl acetals) (for example, poly(vinyl formal), poly(vinyl butyral)), poly(vinyl esters), poly(urethanes), phenoxy resins, poly(vinylidene chloride), poly(epoxides), poly(carbonates), poly(vinyl acetate), cellulose esters, poly(amides), as well as polyvinyl butyral, cellulose acetate, cellulose acetate butyrate, polyester, polycarbonate, poly(acrylic acid), and polyurethane as a transparent hydrophobic binder.

These thickening agents may be used in combination. There are further cited the compounds described on pages 71 through 75 of JP-A No. 64-13546. Of these, polyvinyl alcohols, polyvinylpyrrolidones, hydroxypropyl celluloses, and polyalkylene glycols are preferably used in terms of compatibility with various types of additives and enhancement of dispersion stability of white particles.

### (Polyvinylidene Fluoride Compound)

The display element of the present invention may contain a polyvinylidene fluoride compound (PVDF) in the electrolyte.

The polyvinylidene fluoride compound according to the present invention includes homopolymer of the vinylidene fluoride and copolymer of the vinylidene fluoride and other polymerizable monomer preferably a radical polymerizable monomer. The polymerizable monomer to be copolymerized with the vinylidene fluoride (referred to copolymerizable monomer hereafter) includes, for example, hexafluoropropylene, tetrafluoroethylene, trifluoroethylene, ethylene, propylene, acrylonitrile, vinylidene chloride, methylacrylate, ethylacrylate, methylmethacrylate and styrene.

The polymerizable monomer can be used in an amount of 1 to 50 mol %, preferably 1 to 25 mol % based on the total amount of the monomer. Hexafluoropropylene is used suitably as the polymerizable monomer. Particularly vinylidene fluoride-hexafluoropropylene copolymer in which 1 to 25 mol % of hexafluoropropylene is copolymerized with vinylidene fluoride is used suitably. Further two or more kinds of vinylidene fluoride-hexafluoropropylene copolymer having different copolymerization ration may be used in mixture.

Two or more kinds of the copolymerizable monomers can be used to copolymerize with vinylidene fluoride. For example, copolymers obtained by copolymerization of the combinations of vinylidene fluoride, hexafluoropropylene and tetrafluoroethylene; vinylidene fluoride, tetrafluoroethylene and ethylene; and vinylidene fluoride, tetrafluoroethylene and propylene may be used.

Further a polymer compound such as a polyacrylate polymer compound, polyacrylonitrile polymer compound, and a polyether polymer compound can be used in addition to the polyvinylidene fluoride compound in mixture in the electrolyte according to the present invention. The mixing ratio in this instance is the polymer compound in an amount of 200 parts by weight or less can be mixes based on the 100 parts by weight of the vinylidene fluoride compound.

Number average molecular weight of the polyvinylidene fluoride is generally 10,000 to 2,000,000, and preferably 100,000 to 1,000,000 can be used suitably in the present invention.

### (Casting and Adhesion)

A method can be employed wherein the electrolyte is cast onto at least one of the counter electrode, and another electrode is adhered to the electrolyte, then they are subjected to the thermal process at 65° C. to 180° C. so that the electrolyte is adhered to the counter electrode closely.

A method in which electrolyte in which the metal salt compound is composed to the polymer matrix of the polyvinylidene fluoride is supplied to the at least one of the counter electrodes includes, for example, an extrusion molding method and casting method, and casting method is preferable. Components of the electrolyte such as the metal salt compound, polyvinylidene fluoride compound and electrolyte liquid are mixed and viscosity thereof is adjusted by suitable dilute, and then it is coated on at least one of the counter electrodes via known coater or the like for applied to the casting method and drying to form in the casting method. The coater applied to the casting method includes a doctor coater, a blade coater, a rod coater, a knife coater, a reverse roll coater, a gravure coater, a spray coater, and a curtain coater, which are used depending on the viscosity and layer thickness.

In the present invention it is preferable that after the another electrode surface of the counter electrodes is adhered to the electrode surface on which the electrode is supplied as described above is subjected to thermal process at 65° C. to 180° C. so that the electrolyte is adhered to the counter electrode closely to form the electrolyte layer. Sufficient close adhesion performance between the electrode and electrolyte can be obtained when the thermal processing is carried out at 65° C. or higher, and thermal damage to the material can be removed when it is 180° C. or lower.

### (Other Additives)

Constituting layers of the display element of the present invention may include auxiliary layers such as a protective layer, a filter layer, an antihalation layer, a cross-over light cutting layer, or a backing layer. If desired, may be incorporated in these subsidiary layers are various types of chemical sensitizers, noble metal sensitizers, sensitizing dyes, supersensitizing dyes, couplers, high-boiling point solvents, antifoggants, stabilizers, development restrainers, bleach accelerators, fixing accelerators, color mixing inhibitors, formalin scavengers, toning agents, hardeners, surface active agents, thickeners, plasticizers, lubricants, UV absorbers, anti-irradiation dyes, filter light absorbing dyes, fungicides, polymer latexes, heavy metals, antistatic agents, and matting agents. The auxiliary layers may be provided at a region between the counter electrodes or out side of the counter electrodes.

These additives, described above, are detailed in Research Disclosure (hereinafter referred to as RD), Volume 176 Item/17643 (December 1978), Volume 184 Item/18431 (August 1979), Volume 187 Item/18716 (November 1979), and Volume 308. Item/308119 (December 1989).

Types and listed positions of the compounds cited in these three Research Disclosures are described below.

| | RD 17643 | | RD 18716 | | RD 308119 | |
|---|---|---|---|---|---|---|
| Additive | Page & Class | | Page & Class | | Page & Class | |
| Chemical | 23 | III | 648 | upper right | 96 | III |
| Sensitizer | | | | | | |
| Sensitizing Dye | 23 | IV | 648-649 | | 996-998 | IV |
| Desensitizing | 23 | IV | | | 998 | IV |
| Dye | | | | | | |
| Dye | 25-26 | VIII | 649-650 | | 1003 | VIII |
| Development | 29 | XXI | 648 | upper right | | |
| Accelerator | | | | | | |
| Antifoggant, | 24 | IV | 649 | upper right | 1006-1007 | VI |
| Stabilizer | | | | | | |
| Whitening | 24 | V | | | 998 | V |
| Agent | | | | | | |
| Hardener | 26 | X | 651 | left | 1004-5 | X |
| Surface Active | 26-27 | XI | 650 | right | 1005-1006 | XI |
| Agent | | | | | | |
| Antistatic | 27 | XII | 650 | right | 1006-1007 | XIII |
| Agent | | | | | | |
| Plasticizer | 27 | XII | 650 | right | 1006 | XII |
| Lubricant | 27 | XII | | | | |
| Matting Agent | 28 | XVI | 650 | right | 1008-1009 | XVI |
| Binder | 26 | XXII | | | 1003-1004 | IX |
| Support | 28 | XVII | | | 1009 | XVII |

Metallocene derivatives may be used in the display element of the present invention. It is preferable to use a ferrocene derivative as the metallocene derivative. Examples of a ferrocene derivative include: ferrocene, methyl ferrocene, dimethyl ferrocene, ethyl ferrocene, propyl ferrocene, n-butyl ferrocene, t-butyl ferrocene and 1-1-dicarboxy ferrocene. The metallocene derivatives each may be used alone or in combination of two or more kinds.

### (Layer Configuration)

Constitution layers between the counter electrodes of the display element of the present invention will further be described.

It is possible to provide a constitution layer containing a positive hole transporting material as the constitution layer related to the display element of the present invention. Examples of positive hole transporting materials include aromatic amines, triphenylene derivatives, oligothiophene compounds, polypyrroles, polyacetylene derivatives, polyphenylene vinylene derivatives, polythienylene vinylene derivatives, polythiophene derivatives, polyaniline derivatives, polytoluidine derivatives, CuI, CuSCN, CuInSe₂, Cu(In,Ga)Se, CuGaSe₂, Cu₂O, CuS, CuGaS₂, CuInS₂, GaP, NiO, CoO, FeO, Bi₂O₃, MoO₂, and Cr₂O₃.

### (Substrates)

Preferably employed as substrates usable in the present invention may be synthetic plastic films composed, for example, of polyolefins such as polyethylene or polypropylene, polycarbonates, cellulose acetate, polyethylene terephthalate, polyethylenedinaphthalene dicarboxylate, polyethylene naphthalates, polyvinyl chloride, polyimide, polyvinyl acetals, or polystyrene. Further, preferred are syndiotactic-structured polystyrenes. It is possible to obtain these employing the methods described, for example, in JP-A S62-117708, JP-A H01-46912, and JP-A H01-178505. Further listed are metal substrates of stainless steel, paper supports such as baryta paper or resin-coated paper, supports composed of the above plastic film having thereon a reflection layer, and those described, as a support, in JP-A S62-253195 (pages 29-31). It is possible to preferably employ those described on page 28 of RD No. 17643, from the light column on page 647 to the left column on page 648 of RD No. 18716, and on page 879 of RD No. 307105. As described in U.S. Pat. No. 4,141,735, these supports may be subjected to a thermal treatment at a temperature below Tg so that core-set curl is minimized. Further, the surface of these supports may be subjected to a surface treatment for the purpose of enhancement of adhesion of the support to another constitution layer. In the present invention employed as a surface treatment may be a glow discharge treatment, an ultraviolet radiation treatment, a corona treatment, and a flame treatment. Further employed may be supports described on pages 44-149 of Kochi Gijutsu (Known Technology) No. 5 (published by AZTEC Japan., Mar. 22, 1991). Further listed are those described on page 1009 of RD No. 308119, as well as in the item “Supports” on page 108 of Product Licensing Index Volume 92. Other than the above, employed may be glass substrates and epoxy resins kneaded with glass powder.

### (Electrode)

It is preferable that at least one of the counter electrodes is a metal electrode in the display element of the present invention Employed as a metal electrode may be metals such as platinum, gold, silver, copper, aluminum, zinc, nickel, titanium, or bismuth, as well as alloys thereof, which are known in the art. Preferred metals employed in the metal electrodes are those which exhibit a work function near the oxidation-reduction potential of silver in the electrolyte. Of these, a silver electrode or an electrode composed of silver in an amount of at least 80% is advantageous to maintain reduced silver, and further, results in anti-staining of electrodes Employed as a method to prepare the electrodes may be conventional ones such as an evaporation method, a printing method, an ink-jet printing method, a spin coating method, or a CVD method.

Further, it is preferable that in the display element of the present invention, at least one of the counter electrodes is transparent. Transparent electrodes are not particularly limited as long as they are transparent and electrically conductive. Examples thereof include indium tin oxide (ITO), indium zinc oxide (IZO), fluorine-doped tin oxide (HO), indium oxide, zinc oxide, platinum, gold, silver, rhodium, copper, chromium, carbon, aluminum, silicon, amorphous silicon, and BSO (bismuth silicon oxide). In order to form electrodes, as described above, for example, an ITO layer may be subjected to mask evaporation on a substrate employing a sputtering method, or after forming an ITO layer on the entire surface, patterning may be performed employing photolithography. The surface resistance value is preferably at most 100Ω/□, but is more preferably at most 10Ω/□. The thickness of the transparent electrode is not particularly limited, but is commonly 0.1 to 20 μm.

### (Other Constituting Components of Display Element)

Sealing agents, columnar materials, and spacer particles may be employed in the display element of the present invention, if desired.

Sealing agents are those which perform sealing so that leak to the exterior is minimized, and are called sealants Employed as sealing agents may be heat curing, light curing, moisture curing, and anaerobic during type resins such as epoxy resins, urethane based resins, acryl based resins, vinyl acetate based resins, en-thiol based resins, silicone based resins, or modified polymer resins.

Columnar materials provide a strong self-supporting capability (strength) between substrates. For example, listed may be a cylindrical form, a quadrangular form, an elliptic from, and a trapezoidal form which are arranged at definite intervals in a specified pattern such as a lattice. Further employed may be stripe-shaped ones arranged at definite intervals. It is preferable that the columnar materials are not randomly arranged but arranged at an equal distance so that the interval gradually varies, or a predetermined pattern is repeated at a definite cycle so that the distance between substrates is nearly maintained and image display is not degraded. When the columnar materials are such that the ratio of the area occupied by the display region of a display element is 1 to 40%, sufficient strength as a display element for commercial viability is obtained.

Spacers may be provided between paired substrates in order to maintain a uniform gap between them. As such spacers, exemplified may be spheres composed of resins or inorganic oxides. Further suitably employed are adhesion spacers, the surface of which is coated with thermoplastic resins. Columnar materials only may be provided in order to maintain a uniform gap between the substrates. However, both spacers and columnar materials may be provided. Instead of the columnar materials, only spacers may be employed as space-maintaining members. The diameter of spacers, when a columnar material is formed, is at most its height, but is preferably equal to the above height. When no columnar material is formed, the diameter of spacers corresponds to the thickness of the cell gap.

### (Method to Drive Electrochromic Display Element)

It is preferable to drive a display element so that metal is deposited via voltage application of at least deposition overvoltage and deposition of metal is allowed to continue via application of voltage lower than the deposition overvoltage in the display element of the present invention. It is possible to lower energy for writing, decrease the driving circuit load, as well as to enhance writing rate by performing the above driving operation. It is common knowledge that during the electrode reaction in the electrochemical field, overvoltage exists. Overvoltage is detailed, for example, on page 121 of “Denshi Ido no Kagaku—Denkikagaku Nyumon (Chemistry of Electron Transfer—Introduction to Electrochemistry)” (1996, published by Asakura Shoten). It is possible to consider that the display element of the present invention undergoes an electrode reaction of an electrode with silver in the electrolyte. Consequently, it easy to understand the presence of overvoltage during silver dissolution and deposition. Since the magnitude of overvoltage is controlled by exchange current density, it is assumed that the fact that as shown in the present invention, after formation of blackened silver, deposition of blackened silver continues via application of voltage lower than the deposition overvoltage, is that the surface of the blackened silver results in less excessive electric energy, whereby it is possible to easily perform electron injection.

It is preferable that the control method of transparent state and colored state of the electrochromic display element of the present invention is determined based on the deposition and dissolution overvoltage of the metal ion of the metal salt compound, and the threshold voltage of the coloration and discoloration of the electrochromic compound. For example, in case of the display element having silver complex and iron complex between the counter electrodes, colored state other than black is displayed via non-voltage application, white state is displayed at oxidation side, and black state is displayed at reduction side. In one example of the control method in this instance, the following method included wherein white state is displayed via applying higher voltage than redox potential of the iron complex to oxidize the iron complex, the state is allowed to go back to the colored state other than black via applying the voltage between the redox potential of the iron complex and the deposition overvoltage of the silver complex to reduce the iron complex, black state is displayed via applying lower voltage than deposition overvoltage of the silver complex to deposit silver on the electrode, and discoloration is conducted via applying lower voltage than the redox potential of the iron complex to dissolve silver deposited on the electrode.

Driving operation of the display element of the present invention may be simple matrix driving or active matrix driving. Simple matrix driving, as described in the present invention, refers to the driving method in which electric current is sequentially applied to a circuit in which a positive electrode line containing a plurality of positive electrodes faces a negative electrode line containing a plurality of negative electrodes so that each line intersects in the perpendicular direction. By employing simple matrix driving, it is possible to simplify the circuit structure and the driving IC, resulting in advantages such as lower production cost. Active matrix driving refers to a system in which scanning lines, data lines, and current feeding lines are formed in a checkered pattern and driving is performed by TFT circuits arranged in each of the squares of the checkered pattern. Since it is possible to switch for each pixel, advantages result in gradation as well as memory function. For example, it is possible to employ the circuit described in FIG. 5 of JP-A 2004-29327.

### (Applied Products)

It is possible to apply the display element of the present invention to electronic book related fields, ID card related fields, public information related fields, transportation related fields, broadcasting related fields, account settling fields, and distribution and logistics related fields. Specific examples include door keys, student identification cards, employee ID cards, various club membership cards, convenience store cards, department store cards, vending machine cards, gas station cards, subway and railroad cards, bus cards, cash cards, credit cards, highway cards, driver licenses, hospital medical examination cards, health insurance cards, Basic Resident Registers, passports, and electronic books.

### EXAMPLES

The invention is illustrated practically by means of Examples, to which the present invention is not restricted. The terms “parts” and “%” are used as “parts by weight” and “% by weigh” as far as particularly described otherwise in the Examples.

### Example 1

### Manufacture of Display Element 1

### Comparative Example

### Preparation of Electrolyte 1

Mixture of 0.05 g of polyvinyliden fluoride (PVDF), 1.0 g of ethylmethyl imidazolium-(bis(trifluoromethylsulfonyl)imido) (EMI-TFSI), 0.05 g of silver iodide and 0.01 g of sodium iodide was heated up to 120° C. to dissolve completely, then was cooled down to 100° C., and was coated on a PET substrate with ITO (Electrode 1) to have thickness of 10 μm. Then it was cooled to form Electrolyte Layer 1 on the Electrode 1.

### Manufacture of Display Element 1

### Comparative Example

Silver paste and carbon paste were coated in this order and dried to prepare Electrode 2. Electrolyte Layer 1 on the Electrode 1 and Electrode 2 were superposed so that the Electrolyte Layer 1 was arranged between the Electrodes, and laminate was conducted at 150° C. to obtain Display Element 1.

### Manufacture of Display Element 2

### Example of the Invention

Mixture of 0.05 g of polyvinyliden fluoride (PVDF), 1.0 g of trihexyltetradecylphosphonium-tetrafluoroborate) (CYPHOS IL111), and 0.01 g of sodium iodide was heated up to 120° C. to dissolve completely, then was cooled down to 100° C., and was coated on Electrode 2 to have thickness of 2 μm. Then it was cooled to form Electrolyte Layer 2. Electrolyte Layer 2 on Electrode 2 and Electrolyte Layer 1 on Electrode 1 were superposed so that the Electrolyte Layer 1 was made contact with Electrolyte Layer 2, and laminate was conducted at 150° C. to obtain Display Element 2.

### (Evaluation of Display Elements 1 and 2)

Generation of black silver on the Electrodes 1 and 2 was observed by applying voltage of ±1.5 V between the Electrodes 1 and 2. It was confirmed that generation of black silver on both of Electrodes 1 and 2 in Display 1. In Display 2, generation of black silver on Electrode 1 was confirmed, but generation of black silver on Electrode 2 was not confirmed, to the contrarily. While in Display 1, memory characteristics of black silver generated on Electrode 1 was dissolved by several seconds, in Display 2, it was not dissolved over several ten minutes. Thus it was confirmed that diffusion of compounds to the adjacent layer was inhibited and high image display characteristics were obtained by the present invention as described above.

### Example 2

Evaluation was conducted in the similar manner to Example 1 except that silver iodide was changed to the same mol of bismuth chloride, and the similar result to Example 1 was obtained.

### Example 3

Evaluation was conducted in the similar manner to Example 1 except that 0.1 g of 1,1′-di-n-octyl-4,4′-bipyridinium dichloride (EC Compound 1) was used in place of silver iodide of Example 1, and the result exhibiting similar behavior to blackening in Example 1 was obtained.

### Example 4

### Manufacture of Display Element 3

### Example of the Invention

Display Element 3 was manufactured in the similar manner to Display Element 2 except that silver iodide of Display 2 was added to the same mol of illustrated compound (A-105) (EC Compound 2), and the same mol of EC Compound 1 as EC Compound was added to Electrolyte Layer 2.

### (Evaluation of Display Element 3)

Hue of colored material generated on Electrodes 1 and 2 was observed by applying voltage of ±2.0 V between the Electrodes 1 and 2. It was confirmed that EC Compound 2 colored only when Electrode 1 was cathode, and coloration on Electrode 2 was not observed. EC Compound 1 colored only when Electrode 2 was anode, and coloration on Electrode 1 was not observed.

### Example 5

### Manufacture of Display Element 4

### Example of the Invention

Mixture of 0.05 g of polyvinyliden fluoride (PVDF), 0.01 g of 2,2,6,6,-tetramethylpyperidine 1-oxyl (TEMPO), and 0.005 g of ferrocene and 1.0 g of trihexyltetradecylphosphonium-tetrafluoroborate) (CYPHOS IL111) was heated up to 120° C. to dissolve completely, then was cooled down to 100° C., and was coated on Electrode 1 to have thickness of 10 μm. Then it was cooled to form Electrolyte Layer 3.

Mixture of 0.05 g of PVDF, 1.0 g of EMI-TFSI, and 0.1 g of illustrated compound (A-4), 0.05 g of silver iodide and 0.01 g of sodium iodide was heated up to 120° C. to dissolve completely, then was cooled down to 100° C., and was coated on Electrode 3 to have thickness of 2 μm. Then it was cooled to form Electrolyte Layer 4.

Electrolyte Layer 5 was formed on Electrolyte Layer 4 having thickness of 1 μm in the same manner as Electrolyte Layer 3 except that TEMPO was removed from Electrolyte Layer 3.

Electrolyte Layer 6 was formed on Electrolyte Layer 5 having thickness of 1.5 μm in the same manner as Electrolyte Layer 4 except that illustrated compound (A-4) of Electrolyte Layer 4 was replaced by 0.15 g of illustrated compound (A-13).

Electrolyte Layer 7 was formed on Electrolyte Layer 6 having thickness of 1 μm in the same manner as Electrolyte Layer 5.

Electrolyte Layer 8 was formed on Electrolyte Layer 7 having thickness of 2.0 μm in the same manner as Electrolyte Layer 4 except that illustrated compound (A-4) of Electrolyte Layer 4 was replaced by 0.20 g of illustrated compound (A-105).

Electrolyte Layer 9 was formed on Electrode 2 having thickness of 15 μm in the same manner as Electrolyte Layer 3 except that 0.7 g of titanium dioxide was added to Electrolyte Layer 3.

Electrolyte Layer 8 was superposed to Electrolyte Layer 9 so that they were adjacent to each other, and lamination was conducted at 150° C. Display Element 4 was manufactured by taking electric contacts from Electrodes 4, 6 and 8 so that they were not short-circuited.

### (Evaluation of Display Element 4)

By applying ±4.0 V between connected Electrodes 1 or 2, and Electrodes 4, 6 or 8, each colors of black-and-white, yellow, magenta, cyan, blue, green and red were displayed, and it was confirmed as the full color display element. Further it was confirmed that similar display was possible when the illustrated compounds were replaced by other electrochromic dyes.

1. An electrochromic display element characterized by comprising plural electrolyte layers and containing a redox active compound which is contained in at least one of the electrolyte layers and substantially immiscible with an adjacent electrolyte layer.

2. The electrochromic display element as described in claim 1 characterized in that the redox active compound is a light control material used for an image display.

3. The electrochromic display element as described in claim 2 characterized in that the light control material is a metal salt compound.

4. The electrochromic display element as described in claim 3 characterized in that the metal salt compound is a silver salt compound.

5. The electrochromic display element as described in claim 2 characterized in that the light control material is an electrochromic compound.

6. The electrochromic display element as described in claim 5 characterized in that the electrochromic compound is a compound represented by Formula (A), 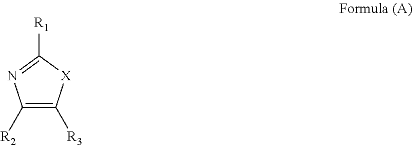
wherein R₁ represents a substituted or unsubstituted aryl group, and R₂ and R₃ each represent a hydrogen atom or a substituent, X represents >N—R₄, an oxygen atom or a sulfur atom, and R₄ represents a hydrogen atom or a substituent.

7. The electrochromic display element as described in claim 2 characterized in that the light control material is contained in every two layers of the plural electrolyte layers.

8. The electrochromic display element as described in claim 7 characterized in that the light control material is an electrochromic compound exhibiting yellow, magenta and cyan color, and full color is displayed by laminating electrolyte layers containing the electrochromic compound.

9. The electrochromic display element as described in claim 1 characterized in that the element contains the redox active compound and a light control material being different from the redox active compound, and the redox active compound is allowed to redox reaction on a pole different from the light control material in addition to redox reaction of the light control material.
